(19) United States
(12) Patent Application Publication
(10) Pub. No.: US 2023/0289791 A1
(43) Pub. Date: Sep. 14, 2023

(54) TRUSTLESS OMNICHAIN COMMUNICATION PROTOCOL PLATFORMS IMPLEMENTING RESOURCE BALANCING

(71) Applicant: LayerZero Labs Ltd., Road Town (VG)

(72) Inventors: Ryan Zarick, Vancouver (CA); Bryan Pellegrino, West Vancouver (CA); Caleb Banister, Vancouver (CA)

(21) Appl. No.: 18/120,475

(22) Filed: Mar. 13, 2023

Related U.S. Application Data
(60) Provisional application No. 63/319,475, filed on Mar. 14, 2022.
(60) Provisional application No. 63/319,494, filed on Mar. 14, 2022.

(51) Int. Cl. G06Q 20/38; G06Q 20/40

(52) U.S. Cl. CPC G06Q 20/389; G06Q 20/403

(57) ABSTRACT

Operations include receiving a request to transfer an amount of a digital asset from a source blockchain having a unified liquidity pool to a destination blockchain of a set of non-source blockchains, wherein the amount of the digital asset defines a transfer size of the transfer, determining whether to initiate the transfer by comparing the transfer size to a balance parameter for the destination blockchain, wherein the balance parameter for the destination blockchain is included within a set of state parameters associated with the source blockchain, in response to determining to initiate the transfer, updating the set of state parameters associated with the source blockchain, and sending, to a destination node maintaining the destination blockchain, a message indicative of a subset of state parameters of the updated set of state parameters. The subset of state parameters includes the transfer size and a credit parameter for the destination blockchain.

### CROSS-REFERENCE TO RELATED APPLICATIONS

The present application claims the benefit of U.S. Provisional Application No. 63/319,475, filed on Mar. 14, 2022 and entitled “SOLVING THE BRIDGING TRILEMMA”, and U.S. Provisional Application No. 63/319,494, filed on Mar. 14, 2022 and entitled “TRUSTLESS OMNICHAIN INTEROPERABILITY PROTOCOL”, the entire contents of which are incorporated herein by reference.

### TECHNICAL FIELD

The disclosure is generally related to blockchains and other distributed ledgers, and more particularly, to trustless omnichain communication protocol platforms implementing resource balancing.

### BACKGROUND

A distributed ledger, or blockchain, is a data structure that maintains electronic transactions (“transactions”) occurring within a network. More particularly, a blockchain can be a chain of cryptographically linked blocks of data (“blocks”), where each block of the blockchain maintains a record of one or more completed transactions. More specifically, a block can include one or more transaction records and a cryptographic digest (“digest”) of the previous block representing the previous batch of transactions. A digest can be generated by a one-way function that produces the same output data for a given input. A one-way function is a function that, from a computational complexity perspective, is “easy” to obtain an output for a given input, but “hard” to invert the output to identify the given input. For example, the digest can be a hash value, which is an output string of data generated by employing a hashing method to an input string of data. Although the input string can be arbitrarily large, the output hash value can be set to a fixed size in accordance with the hashing method used. Digests provide a secure way to maintain integrity of the blockchain. For example, any attempted change of an earlier block will result in the modified digest of the block, which would require modifications to all subsequent blocks in the blockchain (i.e., tamper-proofing).

A transaction generally reflects an update to data maintained by one or more accounts of the network. One example of a transaction is a transfer of a digital asset from one entity to another entity. Another example of a transaction is an exchange of digital assets. An exchange can involve the transfer of a digital asset from a source network having a source blockchain to a destination network having a destination blockchain

### BRIEF DESCRIPTION OF THE DRAWINGS

The disclosure is illustrated by way of examples, and not by way of limitation, and may be more fully understood with references to the following detailed description when considered in connection with the figures, in which:

FIG. 1 is a diagram of an example computer system including a trustless omnichain interoperability protocol platform, in accordance with some embodiments.

FIG. 2 is a diagram of an example system including a trustless omnichain interoperability protocol platform, in accordance with some embodiments.

FIG. 3 is a diagram of an example layout of an endpoint packet, in accordance with some embodiments.

FIGS. 4-5D are flow diagrams of example methods for implementing trustless omnichain interoperability protocol platforms, in accordance with some embodiments.

FIG. 6 is a block diagram of an example computer system including a trustless omnichain interoperability protocol platform implementing resource balancing, in accordance with some embodiments.

FIG. 7 is a diagram of an example set of state information for a blockchain, in accordance with some embodiments.

FIG. 8 is example pseudocode of a resource balancing method used to facilitate a digital asset transfer, in accordance with some embodiments.

FIGS. 9A-9B are flow diagram of example methods for implementing trustless omnichain interoperability protocol platforms with resource balancing, in accordance with some embodiments.

FIGS. 10A-10E are diagrams illustrating an example method for implementing trustless omnichain interoperability protocol platforms with resource balancing, in accordance with some embodiments.

FIG. 11 depicts a block diagram of an illustrative computing device operating in accordance with the examples of the disclosure.

### DETAILED DESCRIPTION

Described herein are systems and methods implementing digital asset exchange protocols with resource balancing. A network can include a decentralized network of nodes (i.e., computing devices), each of which maintains a copy of the blockchain for tracking and managing transactions. A blockchain can maintain transactions related to a digital asset within the network. The nodes are responsible for managing (e.g., verifying) the transactions before appending them to the blockchain. At the core of the blockchain concept are the three pillars of decentralization, transparency, and immutability. No single node within a network can control a blockchain, and actions on the blockchain are verifiable and irreversible. These three pillars create a foundation upon which an entity can act without trusting another entity.

A digital asset refers to electronic property that is owned by an entity (e.g., a person) and has a distinct usage right. Not all networks may support a particular type of digital asset. As such, in some cases, an entity wishing to exchange one digital asset for another digital asset that is not supported by the network may need to make one or more digital asset conversions using intermediate digital assets to accomplish the exchange. There is also an associated counterparty risk if the entity wishes to exchange digital assets with another entity.

A digital asset can be represented by a cryptographic token (“token”). One example of a token is a fungible token, in which the digital asset represented by the fungible token is replaceable with something of equal value. For example, a fungible token can represent a unit of value of a cryptocurrency (e.g., digital coin). Another example of a token is a non-fungible token (NFT). In contrast to fungible tokens, an NFT is a unique token that is not replaceable with something of equal value (i.e., not mutually interchangeable with other objects of the same category).

A smart contract is a sequence of executable instructions stored on a blockchain. The executable instructions specify one or more conditions to be verified and one or more actions to be performed should the conditions be successfully validated. For example, a smart contract can control the transfer of a digital asset between parties specified by the smart contract.

The utility of the blockchain has led to a proliferation of diverse applications, with unique intricacies and requirements. The demand for a diverse set of functionalities spurned the growth of specialized blockchains. Each of these blockchains has fostered immense growth in applications within their own networks. However, isolation between these networks has emerged at a key limitation to adoption. Users and developers are forced to split time, resources, and liquidity between separate blockchains. A natural consequence of “Layer 1” protocols is the need to extend the above-mentioned three pillars to envelope interactions across multiple blockchain simultaneously. The term “layer 1” refers to an initial or base layer of a network architecture (e.g., main blockchain). The term “layer 2” refers to a protocol that is built upon a layer 1 blockchain. For example, a layer 2 protocol can perform a transaction off of the main blockchain for speed and efficiency (i.e., off-chain transaction), and can report the transaction to the main blockchain later. One example of an in-demand interaction between blockchains is the transfer of digital assets.

Transactions have generally been a single-chain concept. Interaction across blockchains has typically required a third-party mechanism outside of the normal blockchain ecosystem. For example, to perform a digital asset exchange that converts between digital assets of two different blockchains, a user typically must leverage a third-party service that facilitates digital asset or token transactions (e.g., transfers, exchanges and/or swaps).

One example of a third-party service is a centralized exchange. In the case of a centralized exchange, a user must deposit digital assets with a trusted third-party authority, which keeps track of the deposit off-chain and grants digital assets on other blockchains as the user requests them. A user must trust that the centralized exchange is tracking deposits and funding withdrawals. Placing trust in a third-party authority defeats the purpose of using blockchain to begin with, and has resulted in the emergence of distributed exchanges.

Another example of a service is a cross-chain decentralized exchange (DEX) or cross-chain bridge (“bridge”). Generally, a bridge is a service that facilitates digital asset or token transfers or swaps between nodes maintaining different blockchains (i.e., cross-chain swaps). For example, some bridges can utilize smart contract-governed consensus protocols to facilitate the automatic minting of digital assets on a blockchain.

However, existing bridges can suffer from a variety of drawbacks. For example, some existing bridges can rely on intermediary chains and protocol-specific tokens, such as intermediary tokens or wrapped tokens, to facilitate transactions. Only a protocol-specific token is minted on the blockchain as opposed to the actual digital asset that the user wants. The user must then exchange the protocol-specific token for the actual digital asset in an additional transaction. These additional transactions and use of protocol-specific tokens and intermediary chains introduce overhead in what should be a single seamless transaction. As another example, some existing bridges can support only a small, limited network of blockchains.

Aspects of the disclosure address the above and other deficiencies by providing technology that implements trustless omnichain interoperability protocol platforms (“platforms”). More specifically, a platform described herein can support a set of cross-chain communication protocols (“communication protocols”). A communication protocol can enable cross-chain communication of data items, such as messages or transactions, within a network that includes that platform. For example, a communication protocol described herein can support direct cross-chain messaging and/or cross-chain transactions. That is, a communication protocol described herein need not rely on any intermediary transactions, intermediary blockchains and/or intermediary tokens to facilitate the transmission of data items. A communication protocol described herein can be defined by a unified protocol, as opposed to an ad-hoc collection of messaging services, in order to serve diverse trust and security requirements of a wide variety of blockchain applications. A platform described herein can provide a foundation to implement other network primitives, such as multicast (e.g., through iterated unicast) and/or publish/subscriber messaging.

For example, a cross-chain data item (e.g., message or transaction) can be sent from a source blockchain to a destination blockchain of a network. More specifically, the data item can be sent from a node maintaining the source blockchain to a node maintaining the destination blockchain. A network can refer to a collection of blockchains that have functionality to support a protocol implemented by a platform. Generally, the transmission of a data item from a source blockchain to a destination block chain can be divided into multiple tasks, including an execution task and a validation task. A communication protocol described herein can separate these tasks into separate modules, which can then be unified through a flexible, customizable platform interface to support cross-chain data transfer protocols. For example, a platform interface can allow user applications associated with respective blockchains (e.g., located on the respective blockchains) to easily configure functionality, cost, and/or security. Accordingly, a communication protocol described herein can be generalized and modular to enable flexibility and customization depending on use case (e.g., a platform can define configuration space supporting a set of configurations).

Each node of a network can be connected to other nodes of the network via a pair of unidirectional “connections,” over which data items (e.g., messages or native digital assets) can be transferred directly from a source node maintaining a source blockchain to a destination node maintaining a destination blockchain different from the source blockchain. Each connection can be backed by liquidity assigned to the destination blockchain to facilitate withdrawals by the user as part of the cross-chain digital asset exchange protocol. Thus, the amount of available liquidity assigned to the destination blockchain can be viewed as the “bandwidth” of the connection between a source blockchain and the destination blockchain. Allowing cross-chain transactions to flow freely provides opportunities for users to consolidate fragmented pockets of liquidity, while also making full use of applications on separate blockchains. The platform described herein can enable a clean and minimal single-transaction cross-chain swap that does not utilize intermediary tokens.

Logic (e.g., high-level exchange logic) of the protocol for sending a data item from a source blockchain to a destination blockchain can be handled by endpoints of the platform, wherein the source blockchain maintains a first endpoint and the destination blockchain maintains a second endpoint. An endpoint is a lightweight client that exists on a blockchain supported by the platform, and any blockchain with an endpoint can conduct cross-chain transactions involving any other blockchain with an endpoint using the platform. In some embodiments, an endpoint is implemented as a series of smart contracts. Accordingly, the endpoints can create a fully-connected network in which every node has a direct connection to every other node.

For example, the endpoints can be used to initialize a protocol to communicate a data item during a cross-chain transaction. In some embodiments, initializing the protocol includes configuring a set of communication protocol settings for the communication protocol.

In some embodiments, configuring the set of communication protocol settings includes the first endpoint receiving a customized settings configuration from a first user application associated with the source blockchain (e.g., located on the source blockchain) and the second endpoint receiving the customized settings configuration from a second user application associated with the destination blockchain (e.g., located on the destination blockchain), and the first endpoint and the second endpoint configurating the set of communication protocol settings in accordance with the customized settings configuration. In some embodiments, initializing the set of communication protocol settings includes configuring the set of communication protocol settings in accordance with a default configuration provided by the platform. For example, this can happen if the user applications select the default configuration, or if the endpoints do not receive a customized settings configuration from the user applications. The first endpoint and the second endpoint can have the same communication protocol settings in order to implement the communication protocol. Accordingly, during initialization of the communication protocol, a set of communication protocol settings can be selected from a range of communication protocol settings with different sets of characteristics depending on the user applications.

For example, the set of communication protocol settings can include a validation library selected from a set of validation libraries supported by the platform. A validation library is responsible for enabling validation of a data item being sent from a source blockchain to a destination blockchain. The source blockchain and the destination blockchain can be configured with the same validation library to support the transmission of a data item in accordance the communication protocol. For example, a validation library can be implemented as an auxiliary smart contract that defines how cross-chain communication should be handled in accordance with the communication protocol. Each validation library can have an associated version number. For example, the set of validation libraries can include multiple versions of at least one validation library. The set of libraries can include one or more libraries that can handle message (e.g., packet) generation, encoding and/or decoding of smart contract address information, computation involved in validating the transaction proof, etc. For example, a library can handle Merkle-Patricia tree validation. As another example, a library can be a zero-nonce proof library. Embodiments described herein provide the ability to swap new validation libraries to achieve particular implementations of the communication protocol. For example, the user applications can specify any version of a validation library to enable data item transmission for a particular use case.

As another example, the set of communication protocol settings can further include a selection of a set of off-chain entities to facilitate data transfer between the source blockchain and the destination blockchain. More specifically, the set of off-chain entities can be selected to facilitate data transfer based on the selected validation library (e.g., as defined by the selected validation library). A set of off-chain entities can include at least two entities that are guaranteed not to collude to enable trustless communication of a data item without the use of any intermediary chains, intermediary or wrapped tokens, etc.

After the communication protocol is initialized to enable the transmission of the data item, the source blockchain can cause the data item to be sent to the destination blockchain in accordance with the set of communication protocol settings. The set of communication protocol settings can be used to ensure that the transaction is valid. The data item can include data indicative of the destination blockchain, and a user payload to be sent to the destination blockchain. For example, the data indicative of the destination blockchain can include at least one of: an address of the destination blockchain, or a smart contract on the destination blockchain. The first endpoint can communicate with the set of off-chain entities, where each off-chain entity of the set of off-chain entities can provide data to the first endpoint and/or the second endpoint for facilitating trustless execution of the communication protocol.

As an illustrative example of a communication protocol supported by the platform, the set of validation libraries can include at least one validation library that enables a cross-chain transaction between the source blockchain and the destination blockchain. To ensure valid delivery, a data item can be delivered to the destination blockchain if and only if the transaction is determined to be valid (e.g., valid and committed). For example, the set of off-chain entities can include a transaction proof entity that can independently produce a transaction proof for the transaction, and a block header entity that can produce a block header for a current block of the source blockchain. The block header is a component of the current block that includes information about the current block (i.e., block metadata). For example, the block header can include at least one of: a timestamp, a digest of the current block (e.g., hash of the current block), a digest of the header of the previous block (e.g., hash of the header of the previous block), a cryptographic nonce value, a Merkle tree root, etc. If the transaction proof and the block header are determined to be in agreement, then the communication protocol can deliver the message to the client on the destination blockchain with the guarantee that the transaction is stably committed on the source blockchain. In other words, due to the lack of collusion between the set of off-chain entities, the communication protocol can guarantee that a transaction on the destination blockchain will be paired with a valid, committed transaction on the source blockchain without involving any indirect methods (e.g., intermediary chains and/or wrapped tokens).

The ability to perform direct cross-chain transactions can enable the development and use of complex cross-chain or inter-chain applications without sacrificing trustlessness or introducing complex intermediary chains and/or smart contracts. Examples of such cross-chain applications include cross-chain bridges, multi-chain yield aggregators, and cross-chain lending protocols. For example, using a communication protocol described herein, users can freely move liquidity between blockchains, allowing for a single pool of liquidity to take part in multiple decentralized finance (DeFi) applications across different blockchains and ecosystems without having to go through third-party systems or intermediary tokens and/or chains.

The configuration of the set of communication protocol settings, including the validation library and the set of off-chain entities, can be used to solve a variety of technical challenges. One technical challenge that can be solved is related to cybersecurity and trust in data item validation. A user application can require a level of trust for validating a data item that crosses through a set of off-chain entities. The level of trust can have an inherently reciprocal relation with the cost of validating the data item. For example, there may be a desire to pay a larger fee to minimize the level of trust required and, by extension the degree of risk, to transfer a large quantity of digital assets (e.g., tokens) from a source blockchain to a destination blockchain. To address this technical challenge, the set of communication protocol settings can enable trust-configurability for validating data items using the communication protocol. For example, the validation library and the set of off-chain can be selected to satisfy a trust characteristic and/or a cost characteristic for validating a data item being sent from a source blockchain to a destination blockchain for a user application.

Another technical challenge that can be solved is extensibility. Generally, user applications should be updated to continue to meet ever-changing demands of users. It can be important to extend support to new blockchains that are added to the network, validation mechanisms, and messaging primitives. Moreover, the communication protocol should allow optimizations to existing code (e.g., debugging) in a manner that precludes the possibility of compromising the cost and/or performance of existing applications.

To address extensibility, the modular design of the set of communication protocol settings including validation libraries can enable the communication protocol to be quickly and easily extended to include new blockchains of the network on demand. A validation library can be immutable when added to the set of validation libraries, which can be used to guarantee that user applications can use a given version of a given validation library without modifying and/or deprecating the underlying code. Moreover, an executor can be used to implement any non-validation tasks (e.g., a task that does not directly pertain to validation). For example, any non-validation task can be factored out of the validation library and handled by the executor, allowing for rapid development and deployment of features without going through rigorous auditing that may be required to introduce a new version of a validation library. The executor can be implemented and/or deployed by any entity, and can perform any non-validation task so long as the non-validation task does not interfere with a validation task that is implemented by the validation library. Accordingly, the set of validation libraries can provide a high degree of freedom in adding and/or upgrade features, and the executor can be leveraged to minimize validation library responsibilities.

Yet another technical challenges that can be solved is cybersecurity against protocol-level vulnerabilities and application-level vulnerabilities. A common theme in the blockchain ecosystem is that the security or trustworthiness of a smart contract is directly related to how long it has been in-use without being compromised. As such, it can be important for existing, well-established code to remain usable in an unmodified state indefinitely. In-place modification of existing code during updates can result in a loss of cybersecurity, which can be unacceptable for some user applications. To balance the need for backwards compatibility with the need to continually update and improve code, embodiments described herein can enable validation libraries to be added or updated while also enabling user selection between a new improved validation library, or an older, well-established validation library. A validation library described herein can be append-only to protect user applications and/or associated users from silent modifications to the validation library. This append-only design of disallowing in-place updates for validation libraries is atypical of other communication protocols that support cross-chain data item transfers and, coupled with the application-specific validation library configuration, can enable improved cross-chain data transfer security. Moreover, the endpoints described herein can be immutable to prevent any entity, including the platform supporting the endpoints, from bypassing data item validation using validation libraries. While it may be theoretically possible for a user application to configure a malicious validation library, existing user applications that have already configured a specific validation library will be left unaffected by the malicious validation library. In addition, on-chain configuration changes can undergo a peer-review process and test period before they are deployed, reducing the likelihood that a user application can configure a malicious validation library in the first place. By allowing a high degree of configurability and democratizing the operation of the off-chain infrastructure, a platform described herein can provide improved cybersecurity and communication-protocol-level configurability. In addition, users can execute their own off-chain entities for relaying data items to connect to existing validation libraries to further control the required level of trust for respective user applications. Further, a platform described herein can provide an off-chain security mechanism to protect against application-level security vulnerabilities.

As yet another example, some existing bridges only support source blockchain composability by allowing composition with other smart contracts on the source blockchain. Composability refers to the ability to combine multiple contracts in a single transaction on a ledger. Such bridges do not support destination blockchain composability by not allowing digital asset transfers to be composed with smart contracts on the destination blockchain. Accordingly, such bridges do not support cross-chain composability (i.e., composability of a digital asset transfer on both the source blockchain and the destination blockchain).

Some bridges can compromise some functionality by giving up at least one of the following: instant guaranteed finality, unified liquidity, or native digital asset transactions. Instant guaranteed finality is the guarantee that any transfer request that is committed on a source blockchain will be successfully committed on a destination blockchain (i.e., there is sufficient asset liquidity on the destination blockchain to facilitate the transfer. Some bridges can achieve instant guaranteed finality by locking a digital asset on the source blockchain and minting a corresponding synthetic asset on the destination blockchain. This mechanism may be functionally equivalent to an unbounded liquidity pool, eliminating the possibility of insufficient liquidity on the destination blockchain. It may be necessary for some bridges to provide instant guaranteed finality, as the absence of any guarantees of finality necessitates a transaction reversion mechanism which will negatively affect the user experience or profitability of the service. If a transaction must be reverted, then bridge can, for example, (1) let the user manually revert, (2) collect sufficient compensation to cover reversion costs from the user upfront (e.g., “gas” fees), or (3) finance the reversion costs itself. Pushing the responsibility of reverting the transaction onto the user is cumbersome and expensive, and collecting sufficient compensation to conduct and revert the transaction upfront is not only inefficient, but also difficult to predict accurately due to reversion cost price fluctuations (e.g., gas price fluctuations). Financing the reversion costs as part of the service can support a more seamless user experience, but can expose the provider to an attack vector of spammed transactions to an endpoint with an empty liquidity pool. However, instant guaranteed finality by itself may be insufficient. For example, some bridges can provide instant guaranteed finality by minting any tokens on the destination blockchain in response to receiving a request from a user to transfer a digital asset. At first glance, this may seem reasonable, but it relies on the user to manually conduct another swap on the destination blockchain using an intermediary token. The use of intermediary tokens can necessitate an additional token swap on the destination blockchain to exchange those intermediary tokens for native tokens. This limited scale may inconvenience a user who bridges digital assets multiple times across different bridges to reach a destination blockchain. Additionally, the additional token swap on the destination blockchain cannot be composed with the original transfer, which can create unnecessary work for users to manually initiate the final token swap.

Some bridges tend to forego native digital asset transactions, instead relying on lock-and-mint semantics where they lock assets on the source blockchain and mint a synthetic asset on the destination blockchain. This can result in a poor user experience, as a user may need to manually swap an intermediary token for a native digital asset in a separate transaction on the destination blockchain. Accordingly, some bridges implement functionality inadequate for supporting efficient cross-chain digital asset transactions (e.g., transfers, exchanges and/or swaps).

Aspects of the disclosure address the above and other deficiencies by providing trustless omnichain communication protocol platforms (“platforms”) implementing resource balancing. More specifically, a platform described herein can include further include bridge that utilizes a resource balancing method to support efficient cross-chain digital asset transactions. A bridge described herein can achieve instant guarantee finality of an entire end-to-end transfer of a native digital asset from a source blockchain to a destination blockchain without the use of an intermediary token. For example, in contrast to some bridges that mint their own intermediary tokens on a destination blockchain in response to a user locking up assets on a source blockchain (“lock-and-mint”), a bridge described herein can conduct digital asset transfers without the use of such intermediary tokens. The use of direct native digital asset transfers can improve bridge scalability, which is made possible at least in part due to a liquidity pool maintained on every blockchain within the network. For example, a user can deposit a digital asset into a liquidity pool on a source blockchain of a network and withdraw the corresponding digital asset from a liquidity pool on a destination blockchain of the network. These deposits and withdrawals can occur directly with native digital assets, without having to employ (e.g., mint) intermediary tokens at any point during the cross-chain transaction (e.g., transfer, swap and/or exchange).

A naive approach to manage liquidity is fractured liquidity, in which each blockchain maintains wholly separate liquidity pool for each pairwise connection (“connection”), and each connection can be granted access to deposit and withdraw from a respective liquidity pool. Such a fractured liquidity approach can reduce (e.g., eliminate) the possibility of race conditions and thus can trivially provide guaranteed finality. However, the fractured liquidity approach can require the creation of a new liquidity pool in response to the creation of a new blockchain within a network. In other words, the number of liquidity pools of a network can grow rapidly based on the number of blockchains of the network. For example, the number of liquidity pools can grow quadratically relative to the number of blockchains. Due to this rapid growth in total required liquidity associated with the fractured liquidity approach, the scalability of a bridge can be severely limited. In addition, the fractured liquidity approach can require that liquidity providers (LPs) stake into each connection's liquidity pool separately, which can require LPs to separately fund multiple liquidity pools to collect fees for the corresponding connections. Accordingly, managing liquidity using the fractured liquidity approach can be undesirable and computationally impractical for networks having a non-trivial number of blockchains.

To address these drawbacks of the fractured liquidity approach, a platform described herein can implement a unified liquidity approach in which all connections deposit and withdraw from a single unified liquidity pool. To provide assurances that the unified liquidity pool is never exhausted (e.g., if multiple concurrent transactions withdraw from the unified liquidity pool), and as will be described in further detail herein, a platform described herein can enable a unified liquidity approach while maintaining instant guaranteed finality. By enabling a unified liquidity approach while maintaining instant guaranteed finality, a platform described herein can support cross-chain composability, which can allow a digital asset transfer from a source blockchain to a destination blockchain to be composed within smart contracts on both the source blockchain and the destination blockchain. Cross-chain composability can maximize the degree of flexibility of the platform. For example, a digital asset can be swapped on the source blockchain, transferred to the destination blockchain using a bridge, and then swapped on the destination blockchain all within the same cross-chain transaction. Cross-chain composability can improve user convenience and can enable various opportunities for cross-chain applications. In addition, the use of the unified liquidity approach with instant guaranteed finality can enable platforms described herein to easily scale across large numbers of blockchains.

Aspects and implementations described herein include technology that can provide a number of technical advantages. For example, embodiments described herein can enable the performance of direct cross-chain transactions. By using off-chain entities to retrieve and send transaction proofs and block headers, respectively, to a destination blockchain to determine whether a transaction originating from a source blockchain is stably committed on the source blockchain, the endpoints of the communication protocol located on the source blockchain and the destination blockchain can designed to be lightweight, and can run on computationally expensive blockchains without incurring prohibitive computational costs. Additionally, by enabling cross-chain digital asset transactions (e.g., transfers, swaps and/or exchanges), embodiments described herein can maximize the utility of digital assets by enabling applications on every supported blockchain to use the digital asset, increase digital asset market liquidity, and digital asset utility.

Eliminating computational overhead associated with lock-and-mint techniques, a bridge described herein can provide a number of benefits to both users and LPs. For example, users no longer need to bridge digital assets multiple times to acquire native digital assets on a destination blockchain. As another example, LPs can achieve high capital efficiency by staking into a single-sided digital asset pool while collecting fees from all incoming transfers regardless of the source blockchain. Additionally, by enabling cross-chain digital asset transactions (e.g., transfers, swaps and/or exchanges), embodiments described herein can allow applications on every supported blockchain to use the digital asset. This can maximize digital asset utility and market liquidity.

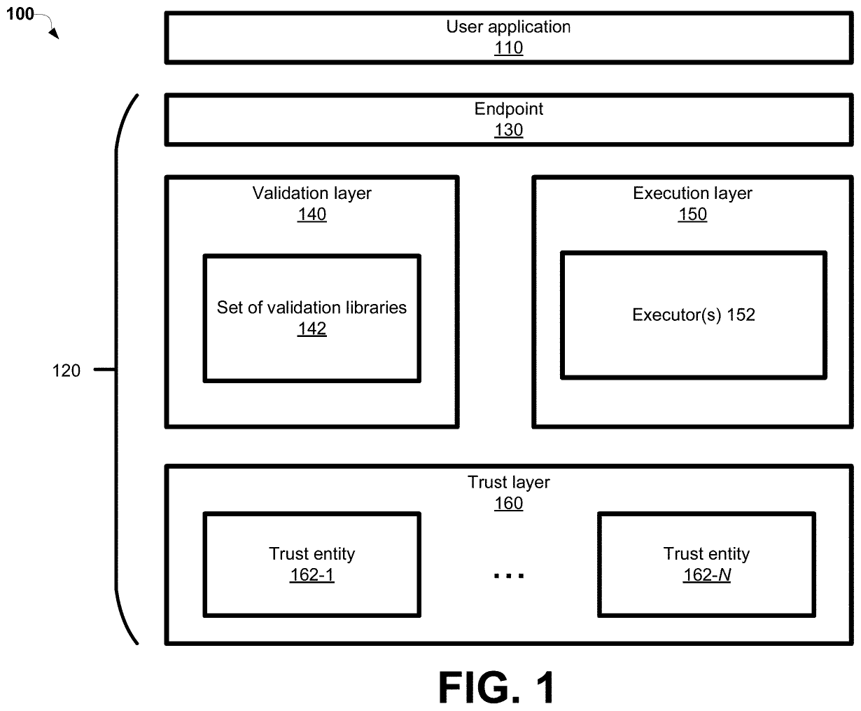

Various aspects of the above referenced methods and systems are described in further detail herein below by way of examples, rather than by way of limitation. Further details regarding implementing digital asset transfer management across distributed ledger networks will now be described in further detail below with reference to FIGS. 1-10.

FIG. 1 is a diagram of an example computer system (“system”) 100, in accordance with some embodiments. As shown, system 100 includes at least one user application 110 associated with a blockchain and trustless omnichain interoperability protocol platform (“platform”) 120. For example, user application 110 can be located on the blockchain. In some embodiments, platform 120 includes a cross-chain bridge (“bridge”) to facilitate transactions between the blockchain and another blockchain of a network. In some embodiments, the blockchain is a source blockchain. In some embodiments, the blockchain is a destination blockchain.

As shown, platform 120 includes at least one endpoint 130, and a set of layers including validation layer 140, execution layer 150, and trust layer 160. Endpoint 130 can be associated with the blockchain. For example, endpoint 130 can be located on the blockchain. In some embodiments, endpoint 130 is implemented as a smart contract on the blockchain. Endpoint 130 is an interface of platform 120. Endpoint 130 can appear to user application 110 as an ordered channel between a source blockchain and a destination blockchain. User application 110 can interact with platform 120 via endpoint 130 to implement a communication protocol. For example, if endpoint 130 is associated with a source blockchain (e.g., located on a source blockchain), then endpoint 130 can receive a data item (e.g., message or transaction) to be sent to a destination blockchain (e.g., a user application located on the destination blockchain), and send the data item to the destination blockchain in accordance with the communication protocol. As another example, if endpoint 130 is associated with a destination blockchain (e.g., located on a destination blockchain), then endpoint 130 can receive a data item sent by an endpoint located on a source blockchain in accordance with the communication protocol.

The set of layers of platform 120 can support the sending and/or receiving of a data item in accordance with the communication protocol, each having a respective responsibility. For example, validation layer 140 handle cybersecurity operations. To do so, validation layer 140 can include set of validation libraries 142 to handle receiving a data item from endpoint 130 (e.g., if endpoint 130 is located on a source blockchain), sending the data item to execution layer 150 and/or trust layer 160, validating the data item at a destination blockchain and/or transmitting the data item to endpoint 130 (e.g., if endpoint 130 is located on a destination blockchain).

Each validation library of set of validation libraries 142 can implement a data item validation mechanism having an associated trust characteristic and/or cost characteristic. For example, each validation library of set of validation libraries 142 can implement a data item validation mechanism that conforms to an application programming interface (API) of the platform to establish a connection to endpoint 130. This can allow the communication protocol to avoid the trap of validation lock-in. In some embodiments, validation layer 140 is append-only. In some embodiments, set of validation libraries 142 is an append-only registry of validation libraries. In some embodiments, each validation library of set of validation libraries 142 is immutable. Set of validation libraries 142 can include one or more validation libraries that can handle message (e.g., packet) generation, encoding and/or decoding of smart contract address information, computation involved in validating the transaction proof, etc. For example, a validation library can handle Merkle-Patricia tree validation. As another example, a validation library can handle zero-nonce proof validation. Each validation library of set of validation libraries 142 can be identifiable through a unique validation library identifier (ID). In some embodiments, the validation library ID is paired with a version (e.g., semantic version) of the validation library.

A validation library can be selected from set of validation libraries 142 to handle transmission of a data item (e.g., message) by a source blockchain and/or receipt of the data item by a destination blockchain. For example, user application 110 can configure the validation library via endpoint 130 as part of a set of configuration settings. The selection of the validation library can be based on a trust characteristic and/or a cost characteristic (e.g., based on much must trust and/or cost user application 110 is willing to tolerate for sending/receiving the data item). A data item can only be sent from a source blockchain to a destination blockchain if the source blockchain and the destination blockchain each are configured with the same validation library (e.g., the same version of the same library). In some embodiments, a validation library is accessed directly on-chain by address. User application 110 can swap out a currently selected validation library for a new validation library.

Execution layer 150 can include set of executors 152 including one or more executors that can be used to implement one or more non-validation tasks. A non-validation task refers to any task that does not directly pertain to validation. Set of executors 152 can minimize responsibilities of validation layer 140 (e.g., responsibilities of set of validation layers 142) by enabling the separation of non-validation tasks from validation tasks. The separation of non-validation tasks from validation tasks enables improved flexibility without compromising security. Set of executors 152 can be implemented and/or deployed by any entity, and can perform any non-validation task so long as the non-validation tasks does not interfere with a validation task that is implemented by a validation library. In some embodiments, set of executors 152 includes multiple executors that each implement one or more respective non-validation task. The operation and implementation of set of executors 152 can be democratized, allowing any entity to execute its own executor of set of executors 152, and by extension allowing any user application to add custom logic to be executed as part of the data item transaction. In some embodiments, set of executors 152 implement a security mechanism to detect a malicious data item originating from a source blockchain by inspecting data originating from the source blockchain, filter the malicious data item and/or block the malicious data item from being sent to a destination blockchain. The security mechanism can be used to increase defense against potentially security vulnerabilities (e.g., exploits) due to, e.g., protocol-level exploits and/or application-level exploits (e.g., due to a bug in an application-level smart contract).

Trust layer 160 can include trust entity 162-1 through trust entity 162-N. A set of trust entities can be selected among trust entity 162-1 through trust entity 162-N to handle transmission of a data item from a source blockchain to a destination block in accordance with a communication protocol. The set of trust entities and the executor(s) of set of executors 152 can collectively form a set of off-chain entities. For example, user application 110 can configure the set of off-chain entities via endpoint 130 as part of a set of configuration settings. The selection of the set of off-chain entities, such as the set of trust entities, can be based on a trust characteristic and/or a cost characteristic (e.g., based on much must trust and/or cost user application 110 is willing to tolerate for sending/receiving the data item). To ensure trustless valid delivery of a data item sent from a source blockchain to a destination blockchain using the communication protocol, there must not be any collusion between trust entities. To prevent collusion between trust entities, each trust entity of the set of trust entities can be an independent trust entity. For example, at least one trust entity of the set of trust entities can be a third-party entity that is not affiliated with the platform.

A high-level description of the operation of system 100 will now be described. It is assumed in this example that user application 110 is associated with a source blockchain, and that endpoint 130 is located on the source blockchain. User application 110 can send a set of parameters for transmission of a data item to endpoint 130. In some embodiments, the data item is a message. For example, the data item can be a packet. In some embodiments, sending the set of parameters includes generating a request by encoding the set of parameters into the request, and sending the request to endpoint 130.

In some embodiments, the set of parameters includes a user payload and a set of auxiliary parameters. The user payload can include any data that user application 110 wants to send to a user application associated with a destination blockchain via the data item (e.g., message). The set of auxiliary parameters can include at least one of: a validation library, a version of the validation library, a nonce value, a source blockchain ID, a source blockchain address, an address of user application 110, a destination blockchain ID, a destination blockchain address, an address of the user application associated with the destination blockchain, an address of each off-chain entity that is being selected, a message offset, a set of executor arguments, etc. The set of executor arguments can specify which executor(s) of set of executors 152 to invoke and the arguments to pass during the invocation the executor(s).

Upon receiving the set of parameters from user application 110, endpoint 130 can forward the set of parameters to validation layer 140. Validation layer 140 can select, based on the set of parameters, a validation library from set of validation libraries 142 to handle transmission of the data item. The validation library can then generate a data item based on the set of parameters. In some embodiments, the validation library emits a data item that encodes parameters for the set of off-chain entities identified from the set of parameters (e.g., executor(s) of set of executors 152 and off-chain entities selected from trust entity 162-1 through 162-N).

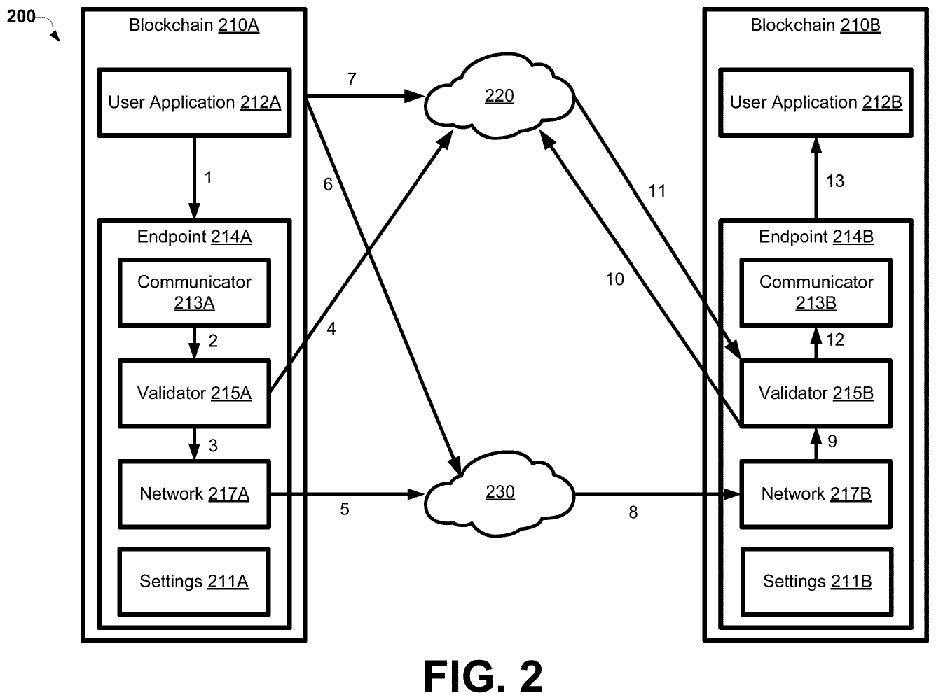

The validation library can send the data item to the set of off-chain entities identified from the set of parameters. The set of off-chain entities can cause the data item to be sent to the corresponding validation library located on the destination blockchain. The validation library located on the destination blockchain can then attempt to validate the data item. Upon successful validation, the data item can be sent to the endpoint located on the destination blockchain. The endpoint located on the destination blockchain can order data items received from the validation library located on the destination blockchain, buffer data items that are received out-of-order, etc. The endpoint located on the destination blockchain can send, to the user application associated with the destination blockchain, the data item from the endpoint located on the destination blockchain. Additionally, set of executors 152 can execute any relevant actions based on the set of parameters, and send corresponding executor data items (e.g., executor messages) to the user application associated with the destination blockchain. Another example of a system including a trustless omnichain interoperability protocol platform will now be described below with reference to FIG. 2.

FIG. 2 is a diagram of an example computer system (“system”) 200 including a trustless omnichain interoperability protocol platform, in accordance with some embodiments. For example, system 200 can be similar to system 100 of FIG. 1. As shown, system 200 includes blockchain 210A and blockchain 210B.

As further shown, blockchain 210A can include user application 212A and endpoint 214, and blockchain 210B can include user application 212B and endpoint 214B. Endpoint 214A and endpoint 214B can enable a user to send and/or receive a data item using the communication protocol. In some embodiments, endpoint 214A and endpoint 214B are each implemented as a series of smart contracts. For example, endpoint 214A can include set of communication protocol settings 211A, communicator component 213A, validator component 215A and network component 217A. Endpoint 214B can include set of communication protocol settings 211B, communicator component 213B, validator component 215B and network component 217B. This design can enable the addition of support for new blockchains without modifying components 213A through 217A and/or components 213B through 217B.

Set of communication protocol settings 211A and set of communication protocol settings 211B can each include a validation library selected from a set of validation libraries supported by system 200 (e.g., validation library of set of validation libraries 140 of FIG. 1). In some embodiments, the validation library is selected based on risk tolerance.

As another example, set of communication protocol settings 211A and set of communication protocol settings 211B can further include a selection of a set of off-chain entities to facilitate data transfer between blockchain 210A and blockchain 210B. For example, the selected validation library can indicate the set of off-chain entities.

As shown, the set of off-chain entities includes trust entity 220, trust entity 230 and set of executors 240. In some embodiments, the trust entity 220 and trust entity 230 are selected based on risk tolerance. More specifically, trust entity 220 and trust entity 230 are guaranteed not to collude, in order to enable trustless communication of data between the blockchain 210A and blockchain 210B without any intermediary chains, wrapped tokens, etc. Set of communication protocol settings 211A and set of communication protocol settings 211B should be the same to implement the communication protocol between blockchain 210A and blockchain 210B (e.g., the same library). To ensure trustless valid delivery of a data item (e.g., message) sent from blockchain 210A to blockchain 210B using the communication protocol, there must not be any collusion between trust entity 220 and trust entity 230. To prevent collusion between trust entity 220 and trust entity 230, trust entity 220 and trust entity 230 can be independent entities. For example, at least one of trust entity 220 or trust entity 230 can be a third-party entity that is not affiliated with the platform.

Endpoint 214A and endpoint 214B can initialize the communication protocol by configuring set of communication protocol settings 211A and set of communication protocol settings 211B, respectively. In some embodiments, configuring set of communication protocol settings 211A and set of communication protocol settings 211B includes endpoint 214A receiving a customized settings configuration from user application 212A and endpoint 214B receiving the customized settings configuration from user 212B, and endpoint 214A and endpoint 214B configuring set of communication protocol settings 211A and set of communication protocol settings 211B, respectively, in accordance with the customized settings configuration.

In some embodiments, configuring set of communication protocol settings 211A and set of communication protocol settings 211B includes endpoint 214A and endpoint 214B each configuring set of communication protocol settings 211A and set of communication protocol settings 211B, respectively, in accordance with a default configuration provided by the platform. For example, this can happen if user application 212A and user application 212B select the default configuration, or if endpoint 214A and endpoint 214B do not receive a customized settings configuration from user application 212A and user application 212B, respectively.

A description of the steps involved in the valid delivery of a data item using system 200 will now be described. In this illustrative example, trust entity 220 is a transaction proof entity and that trust entity 230 is a block header entity. A transaction proof entity is a service that provides a mechanism to send proof for a specified transaction. In some embodiments, a transaction proof entity is a third-party service. In some embodiments, a transaction proof entity is provided by the platform itself. A block header entity is a service that provides a mechanism to read a block header from one blockchain and send the block header to another blockchain. In some embodiments, a block header entity is a third-party service not affiliated with the platform. However, such an example should not be considered limiting.

User application 212A can execute a series of actions as part of a transaction T uniquely identified by transaction identifier t. The format of transaction identifier t can vary depending on the type of blockchain 210A. A step included in transaction Tis the transmission of a data item over the communication protocol with valid delivery condition on transaction T.

More particularly, at step 1, user application 212A can send a request including a set of parameters to communicator component 213A. In some embodiments, the set of parameters includes transaction identifier t, a global identifier pointing to a smart contract on blockchain 210B (“dst”), and a user payload (e.g., any data that user application 212A wants to send to user application 212B). In some embodiments, the set of parameters include a set of transaction proof entity arguments. The set of transaction proof entity arguments can include information (e.g., payment information) in the event that user application 212A wishes to use a reference transaction proof entity.

At step 2, communicator component 213A generates a data item, and sends the data item along with auxiliary information to validator component 215A. In some embodiments, the data item is a message. For example, the data item can be a packet. In some embodiments, the data item generated by communicator component 213A includes dst and the user payload. For example, the data item generated by communicator component 213 can be represented as a packet Packet(dst, user payload). In some embodiments, the auxiliary information includes transaction identifier t and the set of transaction proof entity arguments.

At step 3, validator component 215A notifies network component 217A that the block header for the current block on blockchain 210A needs to be sent to blockchain 210B. For example, validator component 215A can send transaction identifier t and dst to network component 217A, and the receipt of transaction identifier t and dst is what notifies network component 217A that the block header for the current block on blockchain 210A needs to be sent to blockchain 210B.

At step 4, validator component 215A notifies transaction proof entity 220 that the transaction proof for transaction T needs to be retrieved (e.g., fetched) and sent to blockchain 210B. For example, validator component 215A can forward the data item and the auxiliary information to transaction proof entity 220, and the receipt of the data item and the auxiliary information is what notifies transaction proof entity 220 that the transaction proof for transaction T needs to be retrieved and sent to blockchain 210B.

At step 5, network component 217A notifies block header entity 230 to retrieve (e.g., fetch) the block header for the current block on blockchain 210A and send the block header to blockchain 210B. For example, network component 217A can sends dst and a block identifier (ID) of the current transaction to block header entity 230, and the receipt of dst and the block ID is what notifies block header entity 230 to retrieve the block header for the current block on blockchain 210A and send the block header to blockchain 210B.

At step 6, block header entity 230 reads the block header of the current block from blockchain 210A. At step 7, transaction proof entity 220 reads the transaction proof associated with transaction T (proof(t)) from blockchain 210A. Transaction proof entity 220 can further store proof(t) off-chain. In some embodiments, step 6 and step 7 are performed asynchronously.

At step 8, block header entity 230 confirms that the current block of blockchain 210A is stably committed on blockchain 210A. The mechanism for confirming that the current block of blockchain 210A is stably committed on blockchain 210A varies per blockchain. In some embodiments, confirming that the current block of blockchain 210A is stably committed on blockchain 210A includes determining that a number of block confirmations satisfies a threshold condition. For example, determining that a number of block confirmations satisfies a threshold condition can include determining that the number of block confirmations is greater than or equal to a threshold number of block confirmations. In some embodiments, the threshold number of block confirmations is 15. After confirming that the current block of blockchain 210A is stably committed on blockchain 210A (e.g., determining that the number of block confirmations satisfies a threshold condition), block header entity 230 sends the blocker header to network component 217B.

At step 9, network component 217B sends a digest of the block header to validator component 215B. For example, the digest of the block header can be a hash of the block header. At step 10, validator component 215B sends the digest of the block header to transaction proof entity 220.

At step 11, upon receiving the digest of the block header, transaction proof entity 220 sends, to validator component 215B, a list of tuples that match the current block of blockchain 210A. More specifically, the list of tuples can be a list of any data item, transaction identifier t, proof(t) tuples that match the current block of blockchain 210A. In the event that multiple users simultaneously send data items between endpoints 214A and 214B, there may be multiple data items and associated transaction proofs within the same block.

At step 12, validator component 215B determines whether transaction Tis valid. In some embodiments, determining whether transaction Tis valid includes determining whether transaction Tis valid and committed. For example, validator component 217 can determine whether transaction T is valid by determining whether the received transaction proof matches the block header stored by network component 217B. If the received transaction proof and the block header do not match, then transaction Tis determined to be invalid and/or uncommitted and the data item is discarded.

Otherwise, the data item (e.g., Packet(dst, user payload)) is sent to communicator component 213B. Then, at step 13, communicator component 213B sends the data item to user application 212B.

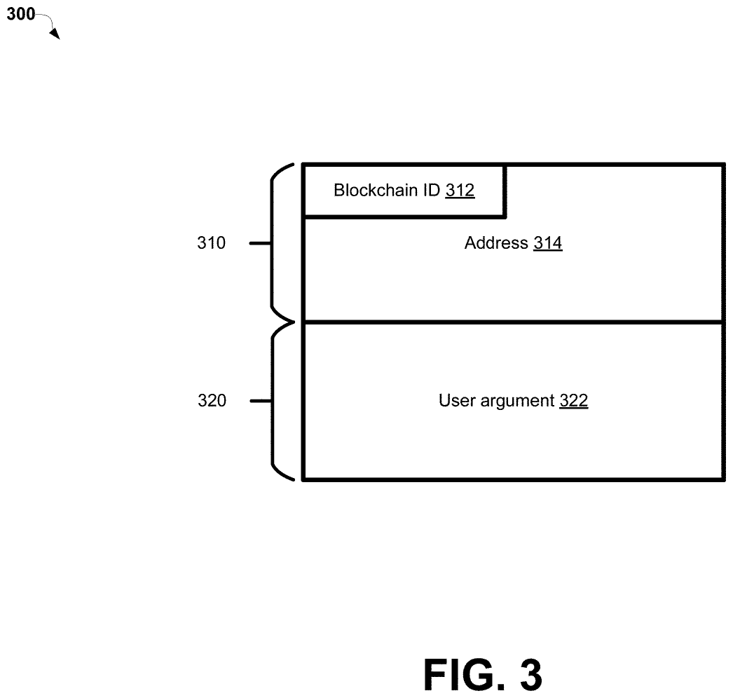

Executing smart contracts on blockchains (e.g., layer 1 blockchains) can be cost prohibitive, especially as the amount of stored data increases. To solve this problem, the task of retrieving transaction proofs is delegated transaction proof entity 220 and the task of retrieving block headers is delegated to block header entity 230. Transaction proof entity 220 and block header entity 230 are off-chain entities that do not collude. This results in endpoint 214A and endpoint 214B being lightweight and cost effective, even on expensive blockchains. An example of a packet that can be used to implement the communication protocol will now be described in detail below with reference to FIG. 3.

FIG. 3 is a diagram of an example layout of an endpoint message 300, in accordance with some embodiments. For example, endpoint message 300 can be a packet. The format of endpoint message 300 can vary depending on the source blockchain (e.g., blockchain 210A of FIG. 2) and the destination blockchain (e.g., blockchain 210B of FIG. 2). As shown, endpoint message 300 can include routing information 310, and user payload 320 including user argument 322 sent by a user application (e.g., user application 212A of FIG. 2). In some embodiments, routing information 310 includes blockchain ID 312 and address 314. Blockchain ID 312 is a unique identifier for a blockchain in the communication protocol system. Address 314 is an address of the recipient smart contract on the destination blockchain. For example, address 314 can have a size of 20 bytes.

A communication protocol described above with reference to FIGS. 1-3 can be used to implement a cross-chain bridge that deals exclusively in native digital assets. Contrary to some bridge designs that issue wrapped tokens or go through intermediary sidechains, a bridge built using a communication protocol described herein to send data items between blockchains can have liquidity pools exist on both blockchains. A user can simply deposit a native digital asset in one liquidity pool and withdraw a native digital asset from another liquidity pool. The communication protocol can enable direct bridges (e.g., 1:1 pricing), automated market making (e.g., ab=k pricing), etc. The guarantee of trustless valid delivery that the communication protocol provides can enable a wide range of cross-chain applications.

For example, communication protocol described above with reference to FIGS. 1-3 can be used to implement a multi-chain yield aggregator. Yield aggregators typically operate within the confines of single-chain ecosystems. One key weakness of these single chain yield aggregation systems is that they cannot take advantage of any yield opportunities outside of their current ecosystem, potentially missing out on many of the best yields. Implementing a multi-chain yield aggregator with the communication protocol described above can allow for strategies that tap into the best opportunities across all ecosystems, increasing access to high-yield opportunities and enabling users to take advantage of market inefficiencies. A multi-chain yield aggregator would be strictly better than a single-chain yield aggregator. For example, in the worst case, the strategy would degrade to taking advantage of opportunities on only one blockchain, and in the best case it would have exponentially more opportunities to choose from.

As another example, a communication protocol described above with reference to FIGS. 1-3 can be used to implement a multi-chain lending protocol. For example, the communication protocol can enable a lending protocol that would allow a user to keep an entire digital asset base in-place on one blockchain, lend out the digital asset base, and borrow directly from a different blockchain. This can eliminate intermediary costs such as bridge and swap fees.

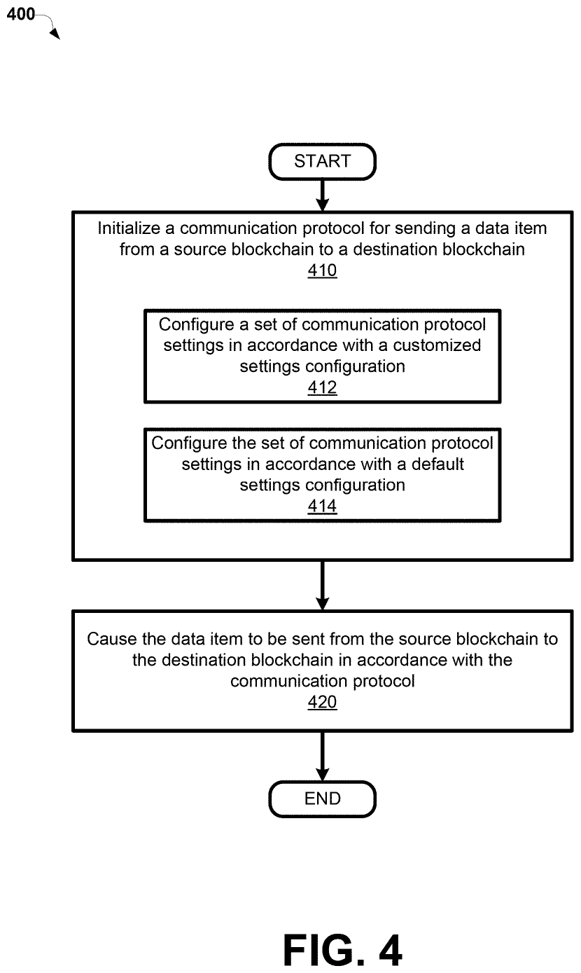

FIG. 4 depicts a flow diagram of an example method 400 for implementing a trustless omnichain interoperability protocol platform, in accordance with some embodiments. For example, method 400 may be performed by endpoint 130 as shown in FIG. 1 or endpoint 214A as shown in FIG. 2. Method 400 may be performed by one or more processing devices that may comprise hardware (e.g., circuitry, dedicated logic, programmable logic, microcode, etc.), executable code (such as is run on a general-purpose computer system or a dedicated machine), or a combination of both. For example, the one or more processing devices can perform individual functions, routines, subroutines, or operations to implement method 400.

At operation 410, processing logic initiates a communication protocol for sending a data item from a source blockchain supported by a platform to a destination blockchain supported by the platform. For example, the data item can be sent from a source node maintaining the source blockchain to a destination node maintaining the destination blockchain. In some embodiments, the data item is a message. For example, the data item can be a packet.

Initializing the communication protocol can include configuring a set of communication protocol settings. In some embodiments, the set of communication protocol settings includes a validation library selected from a set of validation libraries. For example, the set of validation libraries can include one or more validation libraries that are swappable (e.g., the validation library can be replaced with a new validation library). In some embodiments, the set of communication protocol settings includes a set of off-chain entities selected to facilitate the sending of the data item. The set of off-chain entities can be selected in accordance with the validation library. For example, the set of off-chain entities can include a set of trust entities. A first trust entity of the set of trust entities does not collude with a second trust entity of the set of trust entities. The source blockchain and the destination blockchain are configured with at least some of the same set of communication protocol settings (e.g., the same validation library).

In some embodiments, initializing the communication protocol includes, at operation 412, configuring a set of communication protocol settings in accordance with customized settings configuration. For example, configuring the set of communication protocol settings in accordance with the customized settings configuration can include receiving a customized settings configuration from a user application, and configurating the set of settings in accordance with the customized settings configuration received from the user application. The user application can be associated with source blockchain or the destination blockchain. The customized settings configuration can be received as part of a set of parameters associated with a data item to be transmitted from the source blockchain to the destination blockchain.

In some embodiments, initializing the communication protocol includes, at operation 414, configuring the set of communication protocol settings in accordance with a default settings configuration. The default settings configuration can be provided by the platform. For example, this can happen if the user applications select the default configuration (e.g., as part of the set of parameters received from the user applications), or if the endpoints do not receive a customized settings configuration from the user applications.

In some embodiments, initializing the communication protocol includes can include obtaining, from the user application, a set of parameters. In some embodiments, obtaining the set of parameters includes receiving a request from the user application. For example, the request can be generated by encoding the set of parameters. In some embodiments, the set of parameters includes a user payload and a set of auxiliary parameters. The user payload can include any data that user application wants to send to the user application associated with the destination blockchain via the data item. The set of auxiliary parameters can include at least one of: a validation library, a version of the validation library, a nonce value, a source blockchain ID, a source blockchain address, an address of the user application, a destination blockchain ID, a destination blockchain address, an address of the user application associated with the destination blockchain, an address of each off-chain entity that is being selected, a message offset, a set of executor arguments, etc. The set of executor arguments can specify the set of executors and the arguments to pass during the invocation the set of executors.

At operation 420, processing logic causes the data item to be sent from the source blockchain to the destination blockchain in accordance with the communication protocol. For example, causing the data item to be sent in accordance with the communication protocol can include causing the data item to be sent in accordance with the set of communication protocol settings including the validation library and the set of off-chain entities. The set of trust entities of the set of off-chain entities can enable trustless valid delivery of the data item. The set of executors of the set of off-chain entities can implement non-validation tasks, which can enable separation of validation tasks implemented by the validation library from the non-validation tasks.

In some embodiments, causing the data item to be sent from the source blockchain to the destination blockchain includes causing the validation layer to be selected from a set of validation layers. For example, causing the validation layer to be selected from the set of validation layers can include forwarding the set of parameters to a validation layer. The validation library can then generate the data item based on the set of parameters. In some embodiments, the validation library emits a data item that encodes parameters for the set of off-chain entities identified from the set of parameters (e.g., set of executors and set of trust entities). The validation library can send the data item to the set of off-chain entities identified from the set of parameters. The set of trust entities can cause the data item to be sent to the corresponding validation library located on the destination blockchain. The validation library located on the destination blockchain can then attempt to validate the data item. Upon successful validation, the data item can be sent to the endpoint located on the destination blockchain. The endpoint located on the destination blockchain can order data items received from the validation library located on the destination blockchain, buffer data items that are received out-of-order, etc. The endpoint located on the destination blockchain can send, to the user application associated with the destination blockchain, the data item from the endpoint located on the destination blockchain. Additionally, the set of executors can execute any relevant actions based on the set of parameters, and send corresponding executor data items (e.g., executor messages) to the user application associated with the destination blockchain. Further details regarding operations 410-420 are described above with reference to FIGS. 1-3.

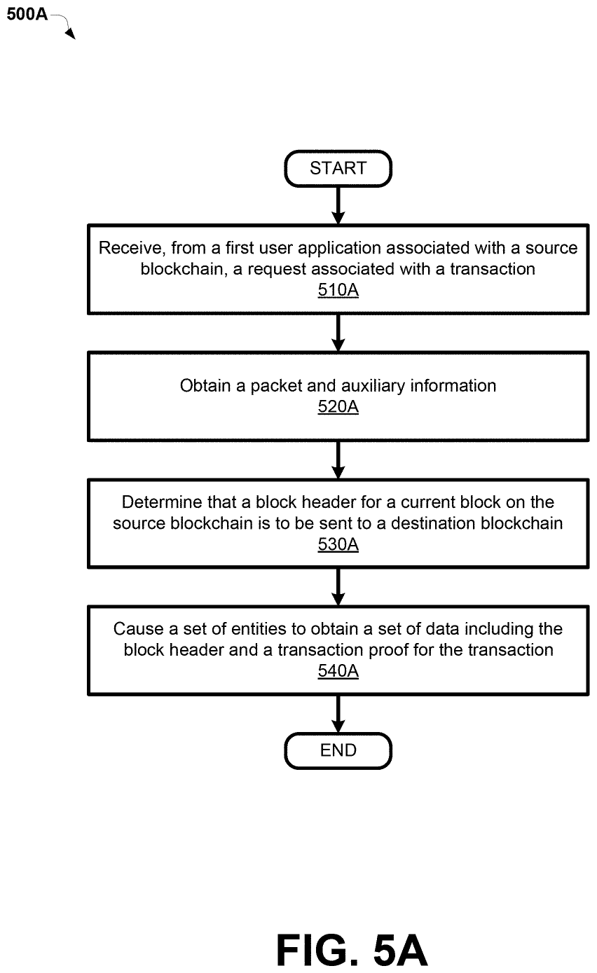

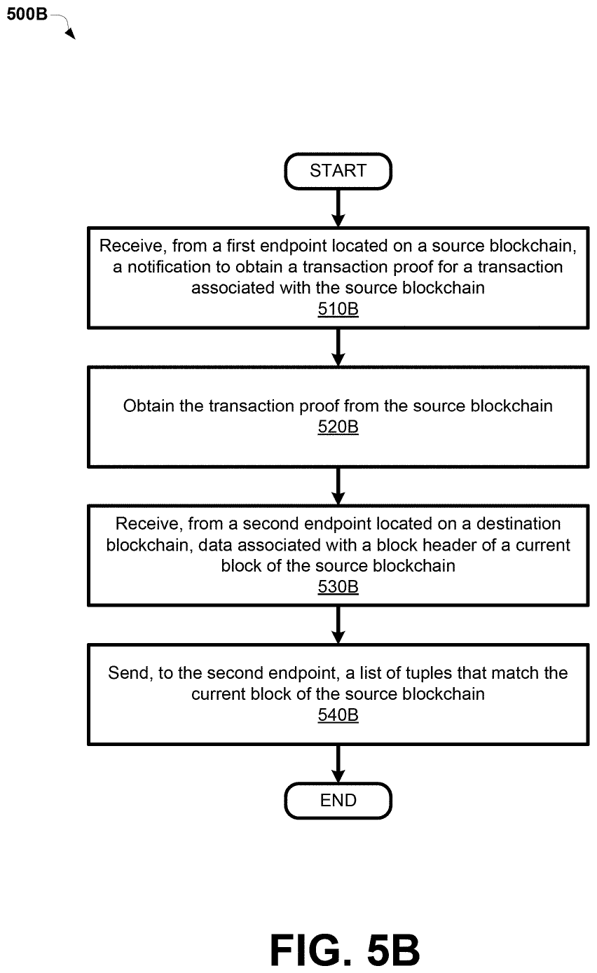

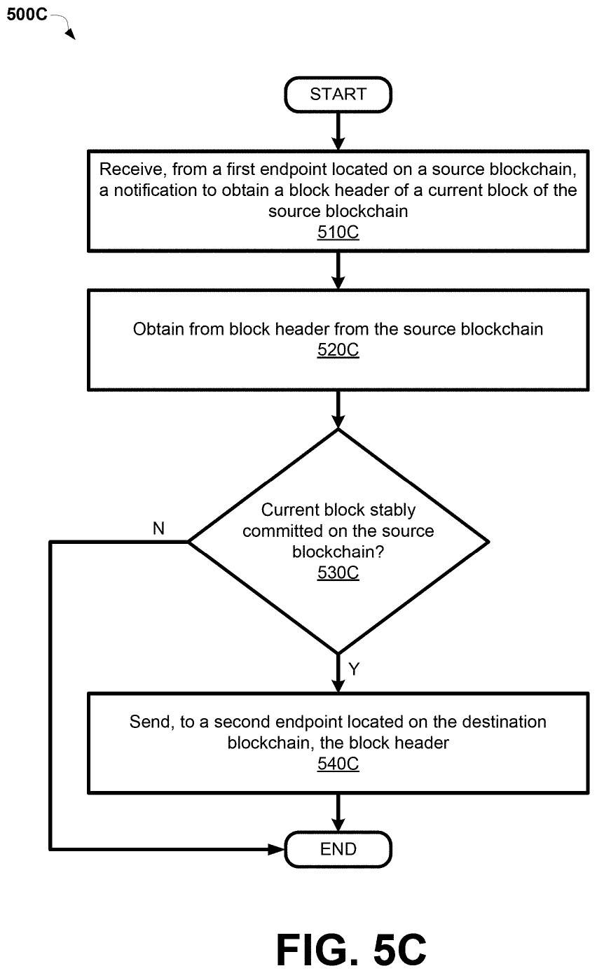

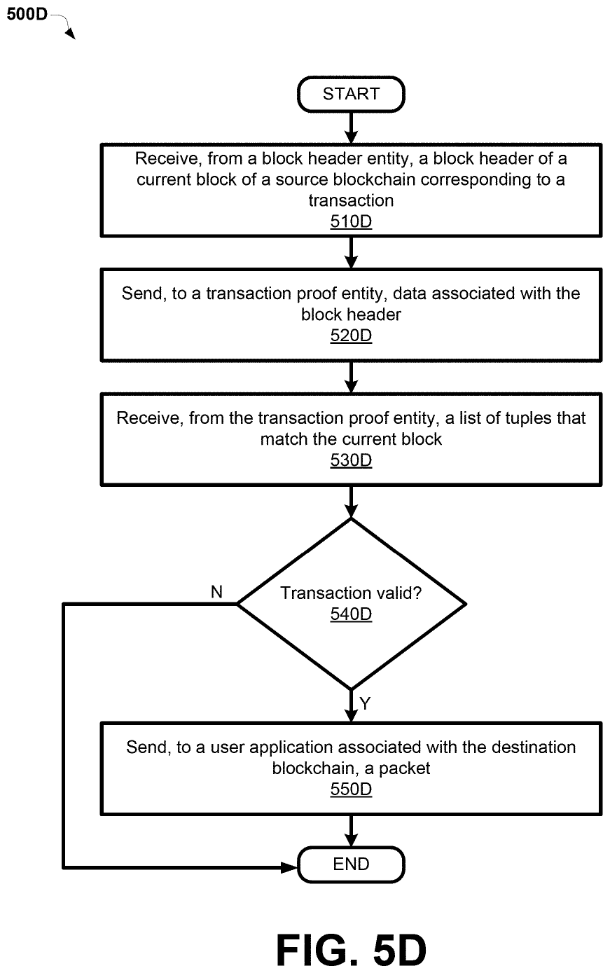

An illustrative example of a method for implementing a trustless omnichain interoperability protocol platform (e.g., causing a message to be sent in accordance with the communication protocol) will now be described in further detail below with reference to FIGS. 5A-5D.

FIG. 5A depicts a flow diagram of an example method 500A for implementing a trustless omnichain interoperability protocol platform, in accordance with some embodiments. For example, method 500A may be performed by endpoint 214A as shown in FIG. 2. Method 500A may be performed by one or more processing devices that may comprise hardware (e.g., circuitry, dedicated logic, programmable logic, microcode, etc.), executable code (such as is run on a general-purpose computer system or a dedicated machine), or a combination of both. For example, the one or more processing devices can perform individual functions, routines, subroutines, or operations to implement method 500A.

At operation 510A, processing logic receives, from a first user application associated with a source blockchain, a request associated with a transaction. The source blockchain is maintained by a set of nodes of a first blockchain network. For example, the first user application can execute a series of actions as part of the transaction. The request can include a set of parameters.

In some embodiments, the set of parameters includes a transaction identifier corresponding to the transaction, a global identifier corresponding to a destination blockchain, and a user payload. The format of the transaction identifier can vary depending on the source blockchain type. In some embodiments, the global identifier is indicative of a smart contract on the destination blockchain. For example, the global identifier can point to the smart contract on the destination blockchain. The user payload can include any data that the user application wants to send to a second user application associated with the destination blockchain. In some embodiments, the set of parameters further includes a set of transaction proof entity arguments. The set of transaction proof entity arguments can include information in the event that the first user application wishes to use a reference transaction proof entity.

At operation 520A, processing logic obtains a packet and auxiliary information. For example, obtaining the packet and auxiliary information can include generating the packet in response to receiving the request, and sending the packet with the auxiliary information for validation. In some embodiments, the packet includes the global identifier and the user payload. In some embodiments, the auxiliary information includes the transaction identifier and the set of transaction proof entity arguments.

At operation 530A, processing logic determines that a block header for a current block on the source blockchain is to be sent to a destination blockchain. The destination blockchain is different from the source blockchain and is maintained on a set of nodes of a second blockchain network different from the first blockchain network. For example, determining that the block header is to be sent to the destination blockchain can include receiving a notification that the block header needs to be sent to the destination blockchain. In some embodiments, receiving the notification that the block header needs to be sent to the destination blockchain includes receiving the transaction identifier and the global identifier. For example, the transaction identifier and the global identifier can be validated prior to receiving the notification that the block header needs to be sent to the destination blockchain.

At operation 540A, processing logic causes a set of entities to obtain a set of data including the block header and a transaction proof for the transaction. For example, processing logic can cause the set of entities to obtain the set of data in response to determining that the block header is to be sent to the destination blockchain. In some embodiments, the set of entities includes a transaction proof entity and a block header entity.

For example, causing the set of entities to obtain the set of data include the block header and the transaction proof can include notifying the transaction proof entity that the transaction proof needs to be retrieved (e.g., fetched) and sent to the destination blockchain. In some embodiments, notifying the transaction proof entity that the transaction proof needs to be retrieved and sent to the destination blockchain includes sending the packet and the auxiliary information to the transaction proof entity, and the receipt of the packet and the auxiliary information is what notifies the transaction proof entity that the transaction proof needs to be retrieved and sent to the destination blockchain. Further details regarding the transaction proof entity are described above with reference to FIG. 2 and will be described below with reference to FIG. 5B.

As another example, causing the set of entities to obtain the set of data include the block header and the transaction proof can include notifying the block header entity that the block header needs to be retrieved (e.g., fetched) and sent to the destination blockchain. In some embodiments, notifying the block header entity that the block header needs to be retrieved and sent to the destination blockchain includes sending the global identifier and a block ID to the block header entity, and the receipt of the global identifier and the block ID is what notifies the block header entity that the block header needs to be retrieved and sent to the destination blockchain. Further details regarding the block header entity are described above with reference to FIG. 2 and will be described below with reference to FIG. 5C.

As described above with reference to FIG. 2 and as will be described in further detail below with reference to FIG. 5D, an endpoint on the destination blockchain can receive the set of data including the block header and the transaction proof, and use the set of data to determine whether the transaction is valid. Upon determining that the transaction is valid, the endpoint on the destination blockchain can send the packet to the second user application. Further details regarding operations 510A-540A are described above with reference to FIGS. 1-3 and will be described in further detail below with reference to FIGS. 5B-5D.

FIG. 5B depicts a flow diagram of an example method 500B for implementing a trustless omnichain interoperability protocol platform, in accordance with some embodiments. For example, method 500B may be performed by transaction proof entity 220 as shown in FIG. 2. Method 500B may be performed by one or more processing devices that may comprise hardware (e.g., circuitry, dedicated logic, programmable logic, microcode, etc.), executable code (such as is run on a general-purpose computer system or a dedicated machine), or a combination of both. For example, the one or more processing devices can perform individual functions, routines, subroutines, or operations to implement method 500B.

At operation 510B, processing logic receives, from a first endpoint located on a source blockchain, a notification to obtain a transaction proof for a transaction associated with the source blockchain. In some embodiments, receiving the notification to obtain the transaction proof includes receiving a packet and auxiliary information. In some embodiments, the packet includes a global identifier corresponding to a destination blockchain and a user payload. In some embodiments, the global identifier is indicative of a smart contract on the destination blockchain. For example, the global identifier can point to the smart contract on the destination blockchain. In some embodiments, the user payload includes data that a first user application associated with the source blockchain wants to send to a second user application associated with the destination blockchain. In some embodiments, the auxiliary information includes a transaction identifier of the transaction and a set of transaction proof entity arguments.

At operation 520B, processing logic obtains the transaction proof from the source blockchain. For example, the transaction proof can be obtained from the source blockchain in response to receiving the notification to obtain the transaction proof. In some embodiments, obtaining the transaction proof from the source blockchain includes reading the transaction proof from the source blockchain. In some embodiments, obtaining the transaction proof from the source blockchain further include storing the transaction proof off-chain.

At operation 530B, processing logic receives, from a second endpoint located on a destination blockchain, data associated with a block header of a current block of the source blockchain. In some embodiments, the data associated with the block header is a digest of the block header. For example, the data associated with the block header can be a hash of the block header.

At operation 540B, processing logic sends, to the second endpoint, a list of tuples that match the current block of the source blockchain. For example, the list of tuples can be sent to the second endpoint in response to receiving the data associated with the block header. More specifically, the list of tuples can be a list of any packet, transaction identifier, and transaction proof tuples that match the current block of the source blockchain.

As described above with reference to FIG. 2 and as will be described in further detail below with reference to FIG. 5D, the second endpoint can determine whether the transaction is valid based on the list of tuples. In response to determining that the transaction is valid, the second endpoint can send the packet to the second user application. Further details regarding operations 510B-540B are described above with reference to FIGS. 1-5A and will be described in further detail below with reference to FIGS. 5C-5D.

FIG. 5C depicts a flow diagram of an example method 500C for implementing a trustless omnichain interoperability protocol platform, in accordance with some embodiments. For example, method 500C may be performed by block header entity 230 as shown in FIG. 2. Method 500C may be performed by one or more processing devices that may comprise hardware (e.g., circuitry, dedicated logic, programmable logic, microcode, etc.), executable code (such as is run on a general-purpose computer system or a dedicated machine), or a combination of both. For example, the one or more processing devices can perform individual functions, routines, subroutines, or operations to implement method 500C.

At operation 510C, processing logic receives, from a first endpoint located on a source blockchain, a notification to obtain a block header of a current block of the source blockchain. In some embodiments, receiving the notification to obtain the block header includes receiving a global identifier corresponding to a destination blockchain and a block ID of the transaction. In some embodiments, the global identifier is indicative of a smart contract on the destination blockchain. For example, the global identifier can point to the smart contract on the destination blockchain.

At operation 520C, processing logic obtains the block header from the source blockchain. For example, the block header can be obtained from the source blockchain in response to receiving the notification to obtain the block header. In some embodiments, obtaining the block header from the source blockchain includes reading the block header from the source blockchain. In some embodiments, obtaining the block header from the source blockchain further include storing the block header off-chain.

At operation 530C, processing logic determines whether the current block is stably committed on the source blockchain. The mechanism for determining whether the current block is stably committed on the source blockchain varies per blockchain. In some embodiments, determining whether the current block is stably committed on the source blockchain includes determining whether a number of block confirmations satisfies a threshold condition. For example, determining whether a number of block confirmations satisfies a threshold condition can include determining that the number of block confirmations is greater than or equal to a threshold number of block confirmations. In some embodiments, the threshold number of block confirmations is 15.

In response to determining that the current block is stably committed on the source blockchain, at operation 540C, processing logic sends the block header to a second endpoint located on the destination blockchain.

As described above with reference to FIGS. 1-2 and 5B and as will be described in further detail below with reference to FIG. 5D, the second endpoint can then generate data associated with the block header (e.g., a digest of the block header), and send the data associated with the block header to a transaction proof entity. The second endpoint can then receive, from the transaction proof entity, a list of tuples that match the current block of the source blockchain. The second endpoint can determine whether the transaction is valid based on the list of tuples. In response to determining that the transaction is valid, the second endpoint can send a packet to a user application associated with the destination blockchain. In some embodiments, the packet includes the global identifier and a user payload. In some embodiments, the user payload includes data that a user application associated with the source blockchain wants to send to the user application associated with the destination blockchain. Further details regarding operations 510C-540C are described above with reference to FIGS. 1-5B and will be described in further detail below with reference to FIG. 5D.

FIG. 5D depicts a flow diagram of an example method 500D for implementing a trustless omnichain interoperability protocol platform, in accordance with some embodiments. For example, method 500D may be performed by endpoint 214B as shown in FIG. 2. Method 500D may be performed by one or more processing devices that may comprise hardware (e.g., circuitry, dedicated logic, programmable logic, microcode, etc.), executable code (such as is run on a general-purpose computer system or a dedicated machine), or a combination of both. For example, the one or more processing devices can perform individual functions, routines, subroutines, or operations to implement method 500D.

At operation 510D, processing logic receives, from a block header entity, a block header of a current block of a source blockchain corresponding to a transaction. For example, as described above with reference to FIGS. 2 and 5C, the block header entity can obtain the block header from the source blockchain (e.g., read the block header from the source blockchain).

At operation 520D, processing logic sends data associated with the block header to a transaction proof entity. To ensure trustless valid delivery, it is assumed that the block header entity and the transaction proof entity are off-chain entities that do not collude. In some embodiments, sending the data associated with block header to the transaction proof entity includes generating the data associated with the block header in response to receive the block header. In some embodiments, the data associated with the block header includes a digest of the block header. For example, the data associated with the block header can include a hash of the block header.

At operation 530D, processing logic receives, from the transaction proof entity, a list of tuples that match the current block. For example, the list of tuples can be sent by the transaction proof entity in response to receiving the data associated with the block header. In some embodiments, the list of tuples includes at least one tuple of a packet, a transaction identifier corresponding to the transaction, and a transaction proof of the transaction, that matches the current block. In some embodiments, a packet of a tuple is a packet including a global identifier corresponding to a destination blockchain and a user payload. In some embodiments, the global identifier is indicative of a smart contract on the destination blockchain. For example, the global identifier can point to the smart contract on the destination blockchain. In some embodiments, the user payload includes data that a user application associated with the source blockchain wants to send to the user application associated with the destination blockchain.

In some embodiments, the list of tuples includes zero tuples of a packet, a transaction identifier corresponding to the transaction, and a transaction proof of the transaction, that matches the current block. In this case, the transaction cannot be validated and the process would end.

At operation 540D, processing logic determines whether the transaction is valid based on the list of tuples. In some embodiments, determining whether the transaction is valid includes determining whether the transaction is valid and committed. In some embodiments, determining whether the transaction is valid includes determining whether the block header and the transaction proof match. In response to determining that the transaction is invalid (e.g., in response to determining that the block header the transaction proof do not match), the process terminates.

In response to determining that the transaction is valid (e.g., in response to determining that the block header and the transaction proof match), at operation 550D, processing logic sends a packet to a user application associated with the destination blockchain. In some embodiments, the packet includes the global identifier and the user payload. Further details regarding operations 510D-550D are described above with reference to FIGS. 1-5C.

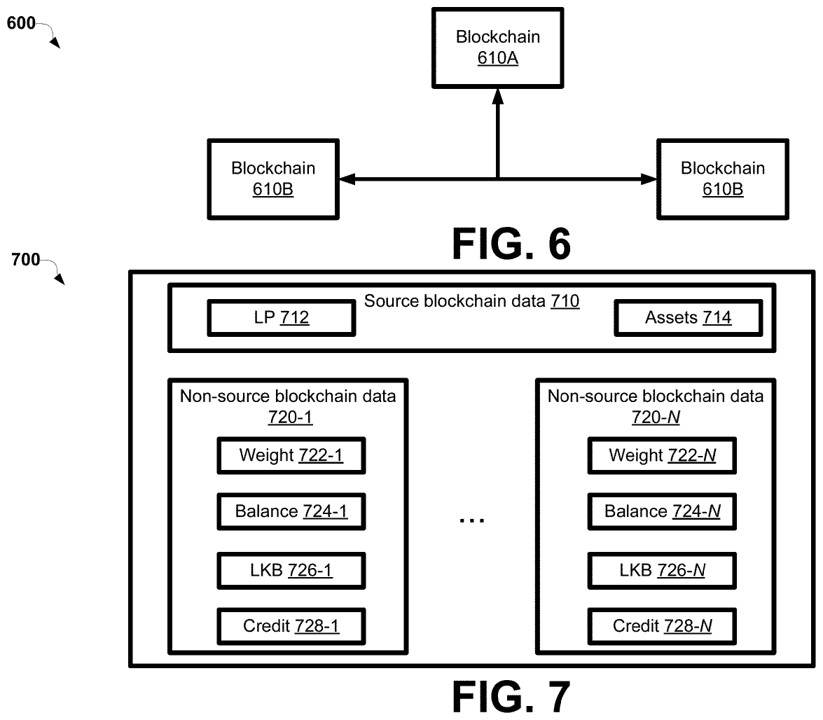

FIG. 6 is a block diagram of an example computer system (“system”) 600 including a trustless omnichain interoperability protocol platform (“platform”) implementing resource balancing, in accordance with some embodiments. As shown, system 600 includes blockchain 610A, blockchain 610B and blockchain 610C. Although system 600 shows three blockchains, system 600 can include any suitable number of blockchains in accordance with embodiments described herein.

System 600 can achieve instant guarantee finality of an entire end-to-end transfer of a native digital asset from a source blockchain of system 600 (e.g., blockchain 610A) to a destination blockchain of system 600 (e.g., blockchain 610B or blockchain 610C) without the use of an intermediary token. For example, a user can deposit a digital asset into a liquidity pool on blockchain 610A and withdraw the corresponding digital asset from a liquidity pool on blockchain 610B or blockchain 610C. Accordingly, these deposits and withdrawals can occur directly with native digital assets, without having to employ intermediary tokens at any point during the cross-chain transaction (e.g., transfer, swap and/or exchange).

More specifically, system 600 can enable a unified liquidity approach while maintaining instant guaranteed finality, where the liquidity pool is a unified liquidity pool. By doing so, system 600 can support cross-chain composability, which can allow a digital asset transfer from blockchain 610A to blockchain 610B to be composed within smart contracts on both blockchain 610A and blockchain 610B. Cross-chain composability can maximize the degree of flexibility of the platform. For example, a digital asset can be swapped on blockchain 610A, transferred to blockchain 610B using system 600, and then swapped on blockchain 610B all within the same cross-chain transaction. Cross-chain composability can improve user convenience and can enable various opportunities for cross-chain applications. In addition, the use of the unified liquidity approach with instant guaranteed finality can enable platforms described herein to easily scale across large numbers of blockchains.

To achieve unified liquidity without compromising instant guaranteed finality, a unified liquidity pool of a blockchain of system 600 can be “soft-partitioned” into equal “liquidity partitions,” where each liquidity partition belongs to another blockchain of system 600 (e.g., blockchain 610B). For example, if blockchain 610A has $X of liquidity in its unified liquidity pool and there are three total blockchains within system 600, then blockchain 610B and blockchain 610C can each be assigned a liquidity partition of $X/2. It is possible to borrow and return liquidity between these liquidity partitions if care is taken to prevent overdrafts and/or race conditions, allowing bridge 620 to keep these liquidity partitions balanced in the face of imbalanced transaction volume.

Each liquidity partition of a unified liquidity pool located on a blockchain can represent the bandwidth available on each channel connecting the blockchain to a respective other blockchain of system 600. In some embodiments, each channel is a unidirectional channel. For example, one channel can connect blockchain 610B to blockchain 610A, and another channel can connect blockchain 610C to blockchain 610A. A channel has a “deficit” if the bandwidth falls below its initial value, and a “surplus” if the bandwidth of the channel exceeds its initial value.

In some embodiments, a transfer includes a deposit of a digital asset on a source blockchain and a withdrawal of a digital asset on a destination blockchain. More specifically, a digital asset can be a native digital asset. For example, assume that the source blockchain is blockchain 610A and the destination blockchain is blockchain 610B. Upon receiving a request to perform the transfer, the resource balancing method can follow a set of rules. For example, the set of rules can include a rule that if any channel on blockchain 610A has a deficit, then at least a portion of newly deposited funds is distributed to close the deficit.

The set of rules can further include another rule that any remaining funds after closing all deficits is distributed across all channels based on an associated weight parameter (w_{s,d}). For example, each connected blockchain of system 600 can have a configurable weight parameter for every other blockchain of system 600. Each weight parameter can have a value that is greater than or equal to zero and less than or equal to one (i.e., 0≤w_{s,d}≤1) and the sum of all weight parameters is equal to one (i.e., Σ_{d} w_{s,d}=1). For each pair of connected blockchains of system 600, there are two weight parameters that are set. More specifically, a weight parameter w_{s,d} can be stored on a source blockchain connected to a destination blockchain, and a weight parameter w_{d,s} can be stored on the destination blockchain. Weight parameter w_{s,d} reflects a proportion of liquidity of the source blockchain to be allocated for transfer from the source blockchain to the destination blockchain. This can be done to provide a larger liquidity buffer, allowing bridge 620 to deal with higher transaction volume for such connections. The weight parameters can be assigned during initial configuration of system 600, and can be modified during operation of system 600 (e.g., when a new blockchain is added to system 600).

Each blockchain of system 600 can store a respective set of state parameters for keeping track of a state of system 600. More specifically, each set of state parameters can be used by its respective blockchain to manage local state to enable cross-chain liquidity while incurring the minimum number of cross-chain messages that must be sent. Each weight parameter can be included in the set of state parameters.

For example, a set of state parameters can include a liquidity provided parameter (lpₛ) stored on a source blockchain (e.g., blockchain 610A). The liquidity provided parameter indicates the initial amount of digital assets that were deposited by the source blockchain. More specifically, the liquidity provided parameter describes the amount of liquidity staked into the unified liquidity pool on a source blockchain without a corresponding withdrawal on any destination blockchain, typically by the service provider. For simplicity, the liquidity provided parameter can also be thought of as the initial size of the unified liquidity pool on the source blockchain, corresponding to the amount of digital assets by the service provider during the initialization of the bridge.

As another example, the set of state parameters can include a digital assets parameter (as), which indicates a size of the unified liquidity pool on the source blockchain. The digital assets parameter can change as deposits and/or withdrawals are made during transactions. As yet another example, the set of state parameters can include a balance parameter (b_{s,x}), which indicates a local allocation of digital assets for transfers from the source blockchain to a non-source blockchain (e.g., the destination block and any other non-source blockchains). That is, a balance parameter stored on a source blockchain describes a portion of digital assets on a respective non-source blockchain that can be used to facilitate transfers from the source blockchain to the destination blockchain. Each balance parameter can represent the maximum channel bandwidth of the connection between a source blockchain and a respective non-source blockchain (i.e., the balance parameter can describe the maximum amount of digital assets that can be transferred from the source blockchain to the non-source blockchain). A balance parameter stored on a source blockchain decreases when funds are transferred from the source blockchain to a destination blockchain. However, the same balance parameter may or may not increase when digital assets are transferred from the destination blockchain to the source blockchain. By ensuring that the maximum channel bandwidth of a connection between a source blockchain and a destination blockchain, indicated by the balance parameter, does not exceed the actual channel bandwidth of the connection between the source blockchain and the destination blockchain, the resource balancing method can guarantee sufficient liquidity for every transfer, and by extension instant guaranteed finality.

As yet another example, a set of parameters can include a last known balance (LKB) parameter stored on a source blockchain (lkb_{x,s}), which indicates the last known value of a balance parameter b_{x,s} from the perspective of the source blockchain with respect to a non-source blockchain. Put differently, the LKB parameter stored on the source blockchain can indicate a (possibly outdated) view of how its digital assets are partitioned between all other blockchains of system 600. An LKB parameter is greater than or equal to the corresponding balance parameter, making them more conservative than the true global state. That is, the destination blockchain cannot have a larger balance than the source blockchain is aware of, which can prevent a situation in which a transfer does not have sufficient digital assets to commit.

As yet another example, a set of parameters can include a credit parameter (c_{s,x}), which indicates an amount of digital assets to be sent in a subsequent transfer from the source blockchain to a non-source blockchain. The resource balancing method can transform each transfer request into multiple smaller transfers to all blockchains within system 600. The credit parameter can be used to batch many of these smaller transfers to reduce operational and/or computational overhead. For example, credits can be accumulated over multiple transactions to obtain a total credit accumulation, and the total credit accumulation can be communicated to a destination blockchain whenever digital assets are transferred to the destination blockchain.

Initially, a sum of balance parameters of a source blockchain for all destination blockchains of system 600 can be equal to an amount of digital assets stored on the source blockchain as indicated by the assets parameter. However, this will not be case as transactions occur due to credits. It is noted that the sum of balance parameters will be less than or equal to the amount of digital assets stored on the source blockchain, preventing a situation where the transferred funds exceed the available assets. For parameters of the set of state parameters that depend on the destination blockchain (e.g., balance and credits), a copy of each of these parameters can also be stored on each destination chain. An example of how a set of state parameters is stored on a given blockchain of system 600 will now be described in further detail below with reference to FIG. 7.

FIG. 7 is a diagram of an example set of state parameters 700, in accordance with some embodiments. It is assumed that set of state parameters 700 is stored on a source blockchain of a network, such as one of blockchain 610A, blockchain 610B or blockchain 610C of FIG. 6. As shown, set of state parameters 700 includes source blockchain data 710 corresponding to the source blockchain, and non-source blockchain data 720-1 through 720-N each corresponding to a respective non-source blockchain of the network connected to the source blockchain. For example, one of the non-source blockchains can be a corresponding destination blockchain as the counterparty for a digital asset transfer.

For example, if the source blockchain is blockchain 610A of FIG. 6, non-source blockchain data 720-1 can be a destination blockchain correspond to blockchain 610B of FIG. 6 and non-source blockchain data 720-N can correspond to blockchain 610C of FIG. 6. Source blockchain data 710 can include the liquidity provided parameter (“LP”) 712 (lpₛ) and the digital assets parameter (“Assets”) 714 (aₛ). Destination blockchain data 720-1 can include weight parameter (“Weight”) 722-1 (w_{s,d}), balance parameter (“Balance”) 724-1 (b_{s,d}), LKB parameter (“LKB”) 726-1 (lkb_{d,s}) and credit parameter (“Credit”) 728-1 (c_{s,d}). Similarly, non-source blockchain data 720-1 can include weight parameter (“Weight”) 722-1 (w_{s,x}), balance parameter (“Balance”) 724-1 LKB parameter (“LKB”) 726-1 (lkb_{x,s}) and credit parameter (“Credit”) 728-1 (c_{s,x}).

Referring back to FIG. 6, a goal of the resource balancing method is to maintain the proportional relationship between the destination chain balance parameter and its respective asset pool while also keeping each balance parameter greater than or equal to its initial value. For example, this goal can be expressed by the condition:

b_{d,s}≈aₛ×w_{s,d} (1)

After initializing system 600 (e.g., configuring each weight parameter), assume that a source blockchain of system 600 (e.g., blockchain 610A) has received a request from a user device to transfer an amount of digital assets to a destination chain of system 600 (e.g., blockchain 610B). The source blockchain (e.g., an endpoint located on the source blockchain such as endpoint 130 of FIG. 1 or endpoint 214A of FIG. 2) can implement a first phase of a resource balancing method to facilitate the transaction. The first phase can be performed to ensure that the transaction is executed with instant guaranteed finality.

Implementing the first phase of the resource balancing method to facilitate the transaction can include initiating the resource balancing method in response to receiving the request from the user device. The source blockchain can determine whether there is a sufficient amount of digital assets on the destination blockchain to facilitate the transfer. The amount of digital assets can be referred to as the transfer size t. Determining whether there is a sufficient amount of digital assets on the destination blockchain to facilitate the transfer can include determining whether the balance parameter for the source blockchain (b_{s,d}) is greater than or equal to the transfer size t. In response to determining that there is an insufficient amount of digital assets on the destination blockchain (e.g., b_{s,d}<t), then the transfer can be rejected.

In response to determining that there is a sufficient amount of digital assets on the destination blockchain to facilitate the transfer (e.g., b_{s,d}≥t), then the set of state parameters for the source blockchain is updated to reflect the deposit by the user device and the intent of the user device to withdraw from the destination blockchain. For example, updating the set of state parameters for the source blockchain can include updating at least the digital assets parameter (aₛ) and the balance parameter (b_{s,d}). More specifically updating the digital assets parameter can include adding the transfer size to the digital asset parameter (aₛ←aₛ+t) and updating the balance parameter can include subtracted the transfer size from the balance parameter (b_{s,d}←b_{s,d}−t).

After updating the set of state parameters, the source blockchain determines, for each non-source blockchain that the source blockchain is connected to, whether a current balance of the destination blockchain is sufficient to continue facilitating transactions to the source blockchain. For example, if the current balance on a destination blockchain is too low to continue facilitating transactions to the source blockchain, then the source blockchain can cause the destination blockchain to redistribute an amount of its digital assets in an attempt to restore the current balance of the destination blockchain to an initial value (i.e., rebalancing of the digital assets of the destination blockchain).

The amount of digital assets to be redistributed to restore the current balance of a non-source blockchain to an initial value is referred to as a difference value for the non-source blockchain (diff_{s,x}). That is each, a difference value for a non-source blockchain is the difference between the current balance on the non-source blockchain and its initial value. In some embodiments, a difference value for a non-source blockchain is determined based on a product term defined by the product of the liquidity provided parameter for the source blockchain and the weight parameter corresponding to the non-source blockchain (e.g., based on lpₛ×w_{s,x}). For example, the current balance on the non-source blockchain can be determined based on a sum term defined by the sum of the LKB parameter of the non-source blockchain and any credits to the non-source blockchain indicated by the corresponding credit parameter (lkb_{x,s}+c_{s,x}). Each difference value is a non-negative value determined based on a difference between the product term and the sum term described above, (lpₛ×w_{s,x}−(lkb_{x,s}+c_{s,x}). In some embodiments, the difference value is determined by determining whether lps×w_{s,x}−(lkb_{x,s}+c_{s,x}) is greater or equal to zero. If lpₛ×w_{s,x}−(lkb_{x,s}+c_{s,x}) is greater than or equal to zero, then the difference value is equal to lpₛ×w_{s,x}−(lkb_{x,s}+c_{s,x}). Otherwise, the difference value is set to zero. Accordingly, in some embodiments, diff_{s,d}←max (0, lpₛ×w_{s,x}−(lkb_{x,s}+c_{s,x})) for each non-source blockchain x. This does not necessarily reflect the immediate value of the balance parameter b_{d,s} for each non-source blockchain, as credit parameter values are only known to the source blockchain. However, each credit parameter can eventually be propagated to the respective non-source blockchain by piggybacking on a transfer request from the source blockchain to the non-source blockchain.

It may be the case that the transfer size t is too small to enable the current balance of each non-source blockchain to be restored to its initial value. To address this, instead of directly redistributing digital assets to restore the current balance of each non-source blockchain to its initial value, the source blockchain can determine a total rebalance amount (Total) defined as the amount of digital assets that would need to be redistributed to restore the current balance of each non-source blockchain to its initial value (e.g., the sum of each diff_{s,x}), and determine an amount of digital assets to allocate to each non-source blockchain based on the total rebalance amount and the transfer size t.

Determining the amount of digital assets to allocate to each non-source blockchain includes determining, for, each non-source blockchain, a respective portion of the transfer size t to be allocated to the non-source blockchain. In some embodiments, determining the respective portion of the transfer size t includes determining, for each non-source blockchain, an adjusted difference value defining the respective portion of the transfer size t. The sum of each adjusted difference value is equal to the transfer size t (instead of the total rebalance amount). In some embodiments, determining an adjusted difference value for a non-source blockchain includes multiplying the minimum of the transfer size t and the total rebalance amount by the ratio of the difference value for the non-source blockchain and the total rebalance amount

$$( {diff}_{s , x} ← min ( Total , t ) \times \frac{{diff}_{s , x}}{Total} ) .$$

Thus, if the total rebalance amount (Total) is less than the transfer size t, then the adjusted difference value for each non-source blockchain is equivalent to its respective difference value that was previously determined. Otherwise, the adjusted difference value for each non-source blockchain is a prorated amount of the transfer size t determined by the ratio of the difference value for the non-source blockchain and the total rebalance amount.

In some embodiments, determining the respective portion of the transfer size t includes determining whether the transfer size t is greater than or equal to the total rebalance amount. If the transfer size t is greater than or equal to the total rebalance amount, then the transfer size t is large enough to restore the current balance of each non-source blockchain to its initial value based on its respective difference value. However, if the transfer size t is less than the total rebalance amount, then it is not possible to restore the current balance of each non-source blockchain to its initial value based on its respective difference value. Thus, an adjusted difference value for a non-source blockchain can be determined by multiplying the transfer size t by the ratio of the difference value for the non-source blockchain and the total rebalance amount

$$( {diff}_{s , x} ← t \times \frac{{diff}_{s , x}}{Total} ) .$$

The source blockchain can then allocate, to each non-source blockchain, the respective portion of the transfer size t to the non-source blockchain. After allocating each portion of the transfer size t to the respective non-source blockchain, the source blockchain can determine an adjusted transfer size t′ defined as the portion of the transfer size t that remains after the allocation. For example, if the transfer size t is less than or equal to the total rebalance amount, then there is no portion of the transfer size t that remains after the allocation (i.e., t′=0). Otherwise, if the transfer size t is greater than the total rebalance amount, then there is a non-zero portion of the transfer size t that remains after the allocation (i.e., t′>0). In some embodiments, the adjusted transfer size t′ is determined as t′←t−min(Total, t).

The source blockchain can then restore the current balance of each non-source blockchain to its initial value. In some embodiments, restoring the current balance of each non-source blockchain to its initial value includes adding, to each non-source blockchain, a respective number of credits to a current number of credits indicated by the credit parameter for the non-source blockchain to obtain an updated credit parameter. For example, the number of credits for a non-source blockchain can be determined based on the adjusted difference value for the non-source blockchain and the adjusted transfer size t′. In some embodiments, the number of credits for a non-source blockchain can be determined as a sum of the adjusted difference value for the non-source blockchain, and a prorated amount of the adjusted transfer balance t′. For example, the prorated amount of the adjusted transfer size t′ for a non-source blockchain can be determined by multiplying the adjusted transfer size t′ by the weight parameter corresponding to the non-source blockchain (w_{s,x}). In some embodiments, the updated credit parameter for each non-source blockchain is determined as c_{s,x}←c_{s,x}+diff_{s,x}+t′×w_{s,x}. More particularly, this can bring the sum of the credits and the LKB for each non-source blockchain as close as possible the initial value of the LKB. If there is any transfer balance remaining (i.e., t′>0), then a non-source blockchain can be issued a credit based on the adjusted transfer size t′ and the weight parameter corresponding to the non-source blockchain (w_{s,x}).

The source blockchain and then generate a message to send to the destination blockchain. More specifically, the message can include the transfer size t and the updated credit parameter for the destination blockchain (c_{s,d}). It may be possible that the updated credit parameter is equal to zero, even if the transfer size is greater than zero. The source blockchain can send the message to the destination blockchain corresponding to the request.

Since the message is notifying the destination blockchain of any outstanding credits as indicated by the updated credit parameter for the destination blockchain (c_{s,d}), the source blockchain can go ahead and update the set of state parameters stored on the source blockchain based on the updated credit parameter for the destination blockchain. For example, updating the set of state parameters stored on the source blockchain can include updating the LKB parameter for the destination blockchain by adding the updated credit parameter to the LKB parameter stored on the source blockchain for the destination blockchain (i.e., lkb_{d,s}←kb_{d,s}+c_{s,d}). After updating the LKB parameter for the destination blockchain, updating the set of state parameters stored on the source blockchain can include setting the updated credit parameter for the destination blockchain to zero (i.e., c_{s,d}←0).

Upon receiving the message from the source blockchain, the destination blockchain can initiate a second phase of the resource balancing method to facilitate the transaction. For example, an endpoint located on the destination blockchain (e.g., endpoint 130 of FIG. 1 and/or endpoint 214B of FIG. 2) can implement the second phase of the resource balancing method. To implement the second phase of the resource balancing method, the destination blockchain can update the set of state parameters stored on the destination blockchain. Updating the set of state parameters stored on the destination blockchain can include updating a digital asset parameter for the destination blockchain by subtracting the transfer size t indicated by the message from the digital asset parameter (e.g., a_{d}←a_{d}−t). Updating the set of state parameters stored on the destination blockchain can further include updating a balance parameter for the destination blockchain by adding the updated credit parameter indicated by the message to the balance parameter (e.g., b_{d,s}←b_{d,s}+c_{s,d}). Updating the set of state parameters stored on the destination blockchain can further include updating a LKB parameter stored on the destination blockchain for the source blockchain by subtracting the transfer size t indicated by the message from the LKB parameter stored on the destination blockchain for the source blockchain (e.g., lkb_{s,d}←lkb_{s,d}−t).

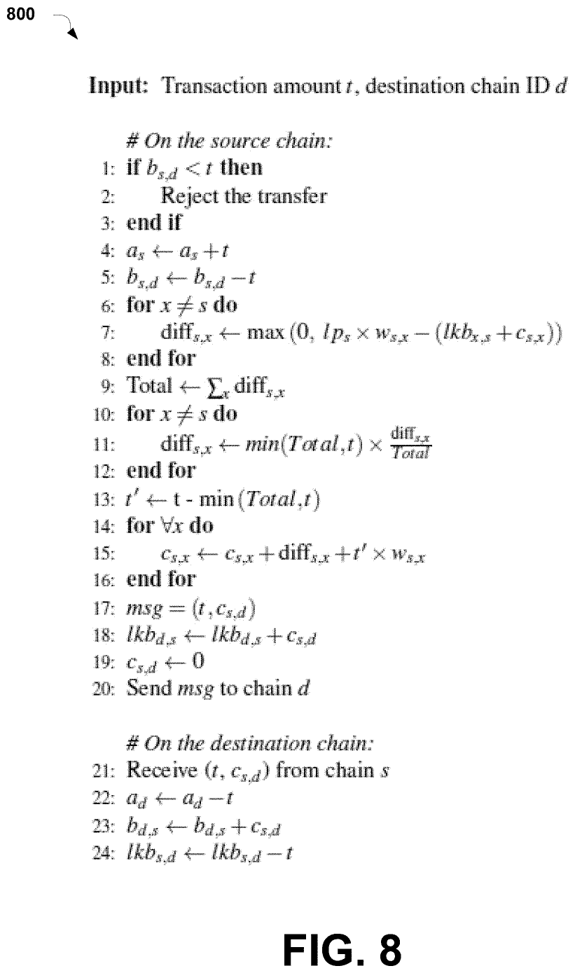

FIG. 8 shows example pseudocode 800 illustrating steps 1-20 performed by the source blockchain (“source chain”) after receiving an input request for a transaction to a destination blockchain (“destination chain”) indicating a transaction amount or size t and destination blockchain (“destination chain”) identifier (ID) d. Moreover, pseudocode 800 further illustrates steps 21-24 performed by the destination chain after receiving the message sent at step 20.

It can be shown that the resource balancing method described above achieves instant guaranteed finality for a transfer that is not rejected by the source blockchain upon receiving a request to perform the transfer (i.e., the transfer is guaranteed to be successfully committed on the destination blockchain specified by the request). In particular, this implies that the unified liquidity pool on the destination chain is guaranteed to have enough digital assets to facilitate the transfer. To prevent the case where multiple concurrent transactions get accepted with their total transfer size exceeding the balance parameter stored on the source blockchain (and thus would not guarantee instant guaranteed finality), the steps of the resource balancing method initiated after receiving the request, up to and including generating the message to be sent to the destination blockchain, can be atomic transactions performed by the source blockchain. More specifically, it can be shown that (1) the balance parameter stored on the destination blockchain (b_{d,s}) is always less than or equal to the LKB parameter stored on the destination blockchain for the corresponding source blockchain (lkb_{s,d}); (2) the sum of all LKB parameters and credit parameters on a given blockchain is always less than or equal to the digital assets parameter stored on the given blockchain; and (3) the LKB parameter stored on the destination blockchain for the corresponding source blockchain (lkb_{s,d}) is always greater than or equal to zero. By using (1)-(3), it can be shown that there are will always be sufficient assets on the destination blockchain to facilitate the transaction, assuming that the source blockchain had not rejected the transaction upon receipt of the request.

It may be possible for user transactions to exhaust the available balance for a particular pair of source blockchain and destination blockchain. To solve this problem in a cost-effective manner, equilibrium fees can be used. Equilibrium fees are transaction fees designed to incentivize users to transfer liquidity in a manner that attempts to keep all balances above their initial value. For example, a user can be charged an equilibrium fee for transferring digital assets from a source blockchain to a destination blockchain when the LKB parameter stored on the source blockchain for the corresponding destination blockchain (lkb_{d,s}) is high, and the user can be paid an equilibrium fee for transferring digital assets from the source blockchain to the destination blockchain when the LKB parameter stored on the source blockchain for the corresponding destination blockchain (lkb_{d,s}) is low. This can incentivize users to deposit digital assets when the available liquidity is low, and thus replenish the liquidity pool. One example of how to determine an equilibrium fee, f_{s,d}, based on the set of state parameters is illustrated by the following equation:

f_{s,d}=(lkb_{d,s}+c_{s,d})−lpₛ×w_{s,d} (2)

That is, equation (2) is the negation of a formula that can be used to calculate the difference value for a destination blockchain during the resource balancing method. Thus, the larger the LKB parameter stored on the source blockchain for the corresponding destination blockchain (lkb_{d,s}), the higher the equilibrium fee for initiating transfers to the corresponding destination blockchain. Conversely, if the LKB parameter stored on the source blockchain for the corresponding blockchain (lkb_{d,s}) is below the initial value for the source blockchain and destination blockchain pair, then there may be an arbitrage opportunity to bridge assets in that direction and pay a negative fee (i.e., collect a reward) for doing so. Accordingly, equilibrium fees can cause users to balance each blockchain connection within system 600, which can help ensure that bridges can continually service transfers without requiring the addition of more base liquidity.

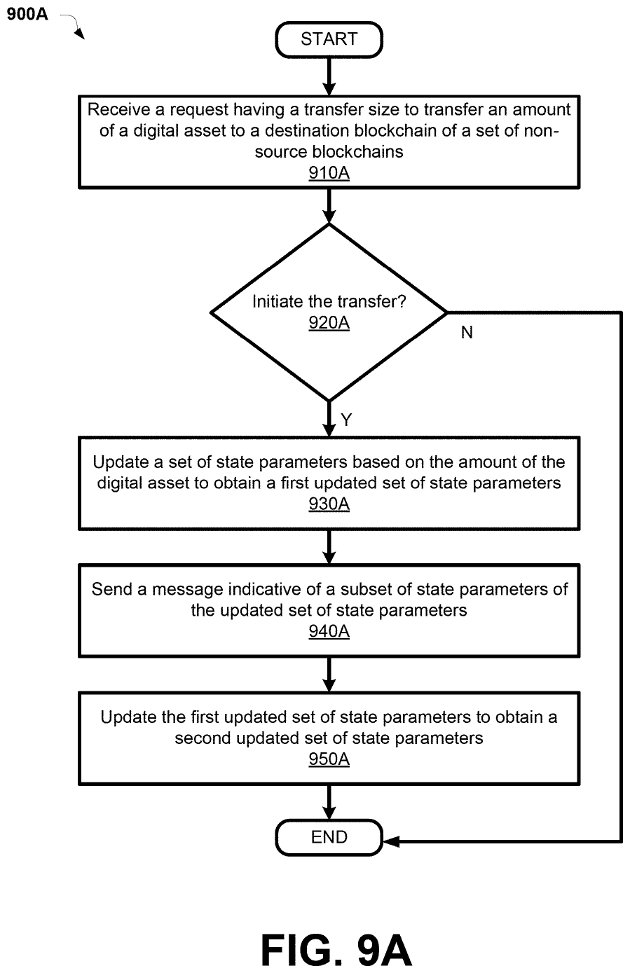

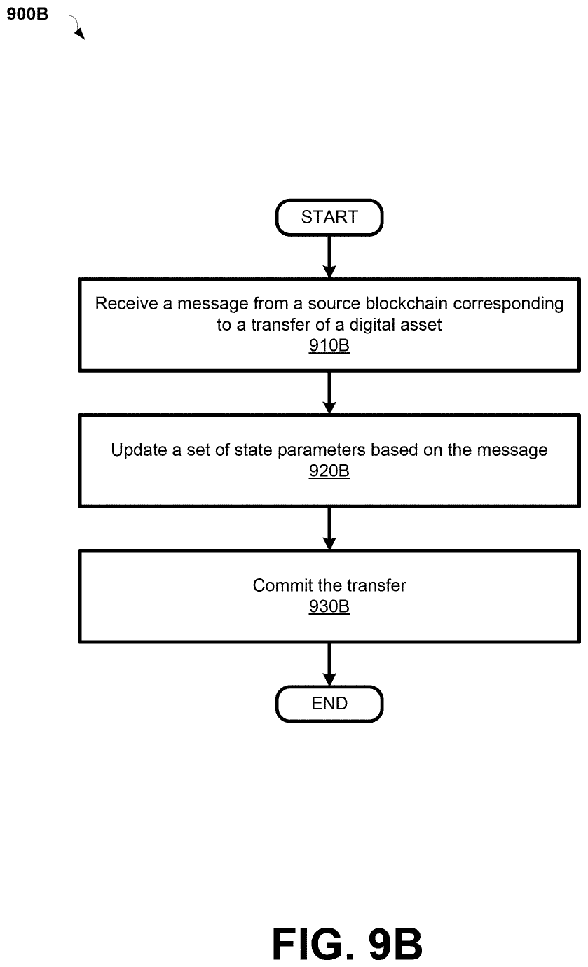

FIG. 9A depicts a flow diagram of an example method 900A for implementing trustless omnichain interoperability protocol platforms with resource balancing, in accordance with some embodiments. For example, method 900A may be performed by a source blockchain (e.g., blockchain 210A of FIG. 2 or blockchain 610A of FIG. 6). For example, method 900A can be performed by an endpoint located on the source blockchain (e.g., endpoint 130 of FIG. 1 or endpoint 214A of FIG. 2). Method 900A may be performed by one or more processing devices that may comprise hardware (e.g., circuitry, dedicated logic, programmable logic, microcode, etc.), executable code (such as is run on a general-purpose computer system or a dedicated machine), or a combination of both. For example, the one or more processing devices can perform individual functions, routines, subroutines, or operations to implement method 900A.

At operation 910A, processing logic receives a request having a transfer size to transfer an amount of a digital asset to a destination blockchain of a set of non-source blockchains. More specifically, the request is received by a source blockchain of a network including the source blockchain and the set of non-source blockchains. The set of non-source blockchains can include one or more blockchains that are not the source blockchain (e.g., at least the destination blockchain). The transfer size or amount of the digital asset can be indicated by units of liquidity. The source blockchain can have an associated unified liquidity pool. Additionally, each non-source blockchain can have a respective unified liquidity pool.

At operation 920A, processing logic determines whether to initiate the transfer based on the transfer size. In some embodiments, determining whether to initiate the transfer can include determining the transfer size satisfies a threshold condition. Determining whether the transfer size satisfies the threshold condition can include determining whether the transfer size is less than or equal to a balance parameter for the destination blockchain. The balance parameter for the destination blockchain can be included within a set of state parameters stored on the source blockchain. If the transfer size does not satisfy the threshold condition (e.g., the transfer size is greater than the balance for the destination blockchain), this means that the current balance for the destination blockchain is insufficient to handle the transfer, and that the transfer should not be initiated. If it is determined that the transfer should not be initiated, then the process ends.

Otherwise, if the transfer size satisfies the threshold condition (e.g., the transfer size is less than or equal to the amount of the digital asset), this means that the current balance for the destination blockchain is sufficient to handle the transfer, and that the transfer can be initiated. At operation 930A, processing logic updates a set of state parameters based on the amount of the digital asset (i.e., transfer size) to obtain an updated set of state parameters. More specifically, the set of state parameters is associated with the source blockchain (e.g., stored on a destination node maintaining the destination blockchain). The set of state parameters associated with the source blockchain maintains state parameters for the source blockchain, as well as each non-source blockchain from the perspective of the source blockchain. For example, the set of state parameters can include the balance parameter for the destination blockchain.

For example, updating the set of state parameters based on the amount of the digital asset can include updating a digital asset parameter for the source blockchain and the balance parameter based on the transfer size. More specifically, the digital asset parameter for the source blockchain can be updated by adding the amount of the digital asset to the digital asset parameter, and the balance parameter can be updated by subtracting the amount of the digital asset from the digital asset parameter.

Updating the set of state parameters can include updating, for each non-source blockchain of the set of non-source blockchains, a respective credit parameter. For example, a credit parameter for the destination blockchain can be updated.

In some embodiments, updating the respective credit parameter for each non-source blockchain includes determining, for each non-source blockchain, a respective difference value based on a set of state parameters stored on the source blockchain. More specifically, a difference value for a non-source blockchain can be determined based on a difference between a product term determined by multiplying a liquidity provided parameter for the source blockchain by a weight parameter stored on the source blockchain for the non-source blockchain, and a sum term determined by adding the LKB parameter for the non-source blockchain to the credit parameter for the non-source blockchain.

In some embodiments, updating the respective credit parameter for each non-source blockchain further includes determining a total rebalance amount by adding each difference value.

In some embodiments, updating the respective credit parameter for each non-source blockchain further includes determining an amount of digital assets to allocate to each non-source blockchain based on the total rebalance amount and the transfer size. Determining the amount of digital assets to allocate to each non-source blockchain includes determining, for, each non-source blockchain, a respective portion of the transfer size to be allocated to the non-source blockchain. In some embodiments, determining the respective portion of the transfer size includes determining, for each non-source blockchain, an adjusted difference value defining the respective portion of the transfer size. The sum of each adjusted difference value is equal to the transfer size (instead of the total rebalance amount). In some embodiments, determining an adjusted difference value for a non-source blockchain includes multiplying the minimum of the transfer size and the total rebalance amount by the ratio of the difference value for the non-source blockchain and the total rebalance amount. Thus, if the total rebalance amount is less than the transfer size, then the adjusted difference value for each non-source blockchain is equivalent to its respective difference value that was previously determined. Otherwise, the adjusted difference value for each non-source blockchain is a prorated amount of the transfer size t determined by the ratio of the difference value for the non-source blockchain and the total rebalance amount.

In some embodiments, determining the respective portion of the transfer size includes determining whether the transfer size is greater than or equal to the total rebalance amount. If the transfer size is greater than or equal to the total rebalance amount, then the transfer size is large enough to restore the current balance of each non-source blockchain to its initial value based on its respective difference value. However, if the transfer size is less than the total rebalance amount, then it is not possible to restore the current balance of each non-source blockchain to its initial value based on its respective difference value. Thus, an adjusted difference value for a non-source blockchain can be determined by multiplying the transfer size by the ratio of the difference value for the non-source blockchain and the total rebalance amount.

In some embodiments, updating the respective credit parameter for each non-source blockchain further includes allocating, to each non-source blockchain, the respective portion of the transfer size to the non-source blockchain. After allocating each portion of the transfer size t to the respective non-source blockchain, the source blockchain can determine an adjusted transfer size defined as the portion of the transfer size that remains after the allocation. For example, if the transfer size is less than or equal to the total rebalance amount, then there is no portion of the transfer size t that remains after the allocation. Otherwise, if the transfer size is greater than the total rebalance amount, then there is a non-zero portion of the transfer size that remains after the allocation.

In some embodiments, updating the respective credit parameter for each non-source blockchain further includes restoring the current balance of each non-source blockchain to its initial value. In some embodiments, restoring the current balance of each non-source blockchain to its initial value includes adding, to each non-source blockchain, a respective number of credits to a current number of credits indicated by the credit parameter for the non-source blockchain to obtain an updated credit parameter. For example, the number of credits for a non-source blockchain can be determined based on the adjusted difference value for the non-source blockchain and the adjusted transfer size. In some embodiments, the number of credits for a non-source blockchain can be determined as a sum of the adjusted difference value for the non-source blockchain, and a prorated amount of the adjusted transfer balance. For example, the prorated amount of the adjusted transfer size for a non-source blockchain can be determined by multiplying the adjusted transfer size t′ by the weight parameter corresponding to the non-source blockchain. More particularly, this can bring the sum of the credits and the LKB for each non-source blockchain as close as possible the initial value of the LKB. If there is any transfer balance remaining, then a non-source blockchain can be issued a credit based on the adjusted transfer size and the weight parameter corresponding to the non-source blockchain.

At operation 940A, processing logic sends a message indicative of a subset of state parameters of the updated set of state parameters. Sending the message can include generating the message. More specifically, the subset of state parameters can include the transfer size and the updated credit parameter for the destination blockchain, and the message can be sent to a destination node maintaining the destination blockchain. It may be possible that the updated credit parameter is equal to zero, even if the transfer size is greater than zero.

At operation 950A, processing logic updates the first updated set of state parameters to obtain a second updated set of state parameters. More specifically, the second updated set of state parameters is associated with the source blockchain. Since the message is notifying the destination blockchain of any outstanding credits as indicated by the updated credit parameter for the destination blockchain, the source blockchain can proceed to update the first updated set of state parameters. For example, updating the first updated set of state parameters associated with the source blockchain can include updating the LKB parameter for the destination blockchain by adding the updated credit parameter for the destination blockchain to the LKB parameter stored on the source blockchain for the destination blockchain (i.e., lkb_{d,s}←lkb_{d,s}+c_{s,d}). After updating the LKB parameter for the destination blockchain, updating the first updated set of state parameters can include setting the updated credit parameter for the destination blockchain to zero (i.e., c_{s,d}←0).

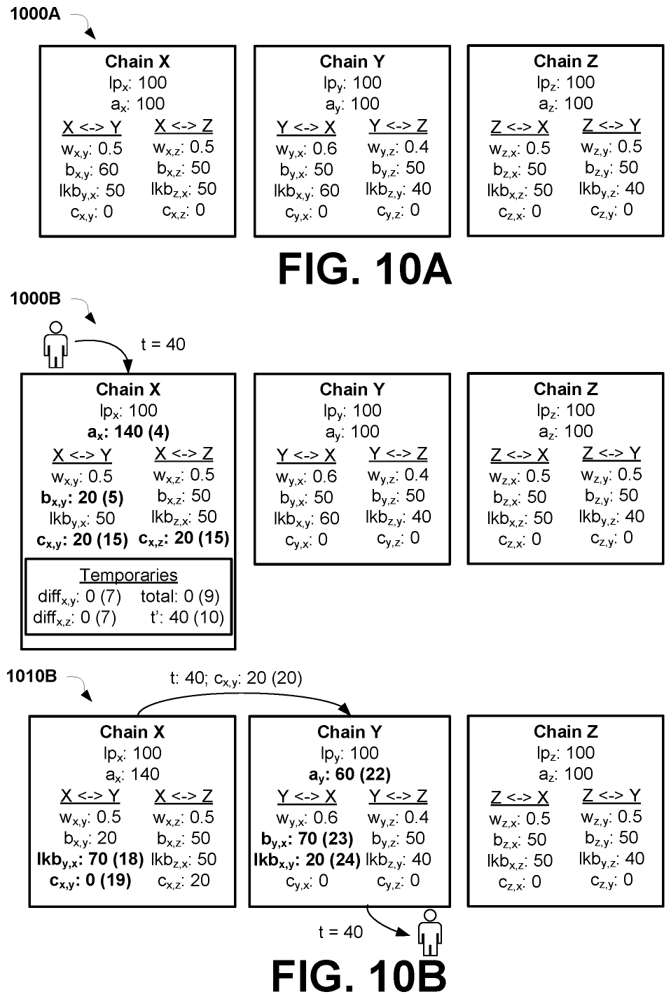

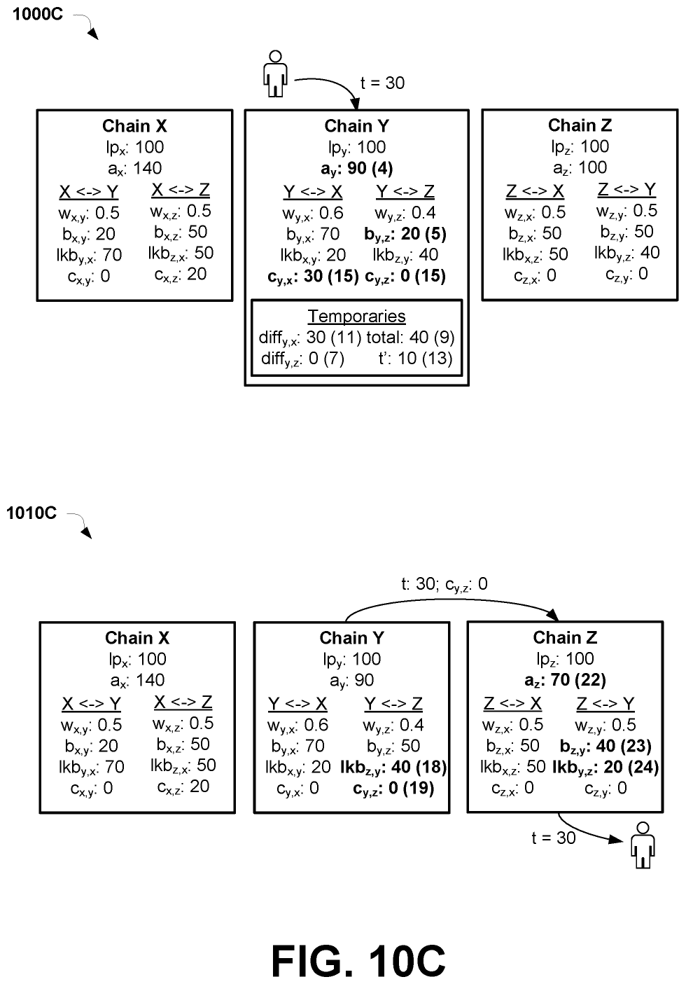

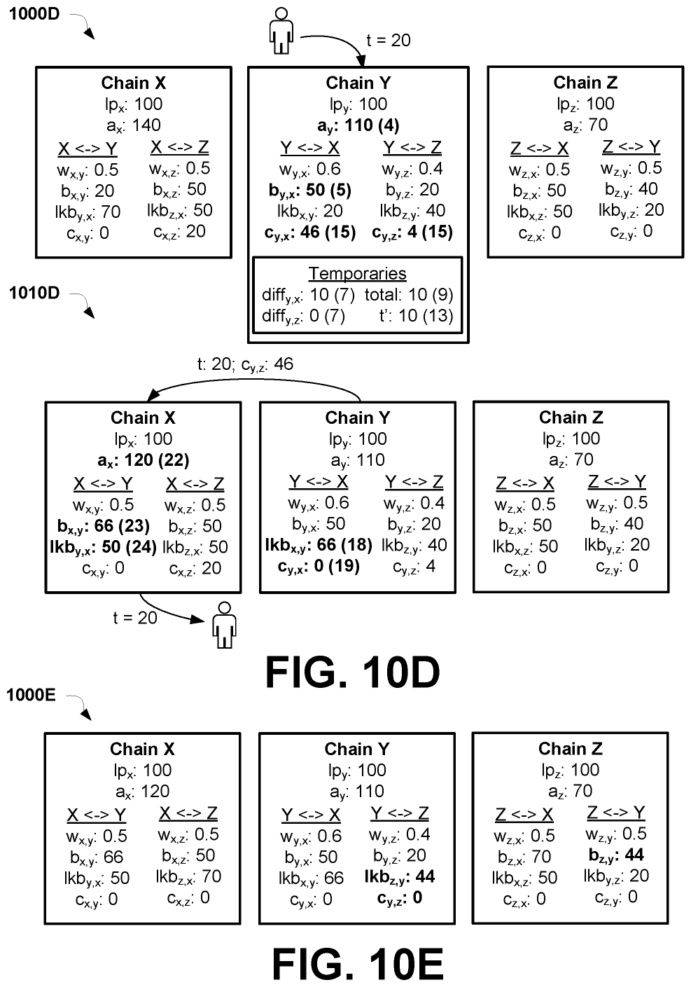

The destination blockchain, upon receiving the message, can commit the transfer, and a set of state parameters associated with the destination blockchain can be updated to reflect the transfer, as will be described in further detail below with reference to FIG. 9B. Further details regarding operations 910A-950A are described above with reference to FIGS. 6-8 and will be described in further detail below with reference to FIGS. 10A-10E.

FIG. 9B depicts a flow diagram of an example method 900B for implementing trustless omnichain interoperability protocol platforms with resource balancing, in accordance with some embodiments. For example, method 900B may be performed by a destination blockchain (e.g., blockchain 210B of FIG. 2 or blockchain 610B of FIG. 6). For example, method 900B can be performed by an endpoint located on the source blockchain (e.g., endpoint 130 of FIG. 1 or endpoint 214B of FIG. 2). Method 900B may be performed by one or more processing devices that may comprise hardware (e.g., circuitry, dedicated logic, programmable logic, microcode, etc.), executable code (such as is run on a general-purpose computer system or a dedicated machine), or a combination of both. For example, the one or more processing devices can perform individual functions, routines, subroutines, or operations to implement method 900B.

At operation 910B, processing logic receives a message from a source blockchain corresponding to a transfer of a digital asset. More specifically, the message can include an amount of the digital asset being transferred (i.e., a transfer size) and an updated credit parameter, which can be generated as described above with reference to FIGS. 6-9A.

At operation 920B, processing logic updates a set of state parameters based on the message. More specifically, the set of state parameters is associated with the destination blockchain (e.g., stored on a destination node maintaining the destination blockchain). The set of state parameters associated with the destination blockchain maintains state parameters for the destination blockchain, as well as each non-destination blockchain of the network from the perspective of the destination blockchain.

Updating the set of state parameters stored on the destination blockchain can include updating a digital asset parameter for the destination blockchain by subtracting the transfer size indicated by the message from the digital asset parameter. Updating the set of state parameters stored on the destination blockchain can further include updating a balance parameter for the destination blockchain by adding the updated credit parameter indicated by the message to the balance parameter. Updating the set of state parameters stored on the destination blockchain can further include updating a LKB parameter stored on the destination blockchain for the source blockchain by subtracting the transfer size indicated by the message from the LKB parameter stored on the destination blockchain for the source blockchain.

At operation 930B, processing logic commits the transfer. For example, committing the transfer can include causing an amount of the digital asset to be sent to a user in accordance with the message (e.g., grant the amount of the digital asset to the user). Further details regarding operations 910B-930B are described above with reference to FIGS. 6-9A and will be described in further detail below with reference to FIGS. 10A-10E.

FIGS. 10A-10E are diagrams illustrating an example method for implementing trustless omnichain interoperability protocol platforms with resource balancing, in accordance with some embodiments. FIG. 10A illustrates diagram 1000A showing an initial state of blockchain X (“Chain X”), blockchain Y (“Chain Y”) and blockchain Z (“Chain Z”) of a system that can implement a resource balancing method to transfer digital assets from a source blockchain to a destination blockchain, as described above with reference to FIGS. 6-9B. For example, blockchain X, blockchain Y and blockchain Z can be similar to blockchain 610A, blockchain 610B and blockchain 610C, respectively, of FIG. 6.

As shown in diagram 1000A, blockchains X-Z can each be associated with a respective initial state defining by a respective set of state parameters. In this illustrative example, the set of state parameters for blockchain X in the initial state includes a liquidity provided parameter (lpₓ) having a value of 100, a digital assets parameter (aₓ) having a value of 100, a weight parameter for blockchain Y (w_{x,y}) having a value of 0.5, a weight parameter for blockchain Z (w_{x,z}) having a value of 0.5, a balance parameter value for blockchain Y (b_{x,y}) having a value of 60, a balance parameter value for blockchain Z (b_{x,z}) having a value of 50, an LKB parameter for blockchain Y (lkb_{y,x}) having a value of 50, an LKB parameter for blockchain Z having a value of 50, a credit parameter value for blockchain Y (c_{x,y}) having a value of 0, and a credit parameter value for blockchain Z (c_{x,z}) having a value of 0.

The set of state parameters for blockchain Y in the initial state includes a liquidity provided parameter (lp_{y}) having a value of 100, a digital assets parameter (a_{y}) having a value of 100, a weight parameter for blockchain X (w_{y,x}) having a value of 0.6, a weight parameter for blockchain Z (w_{y,z}) having a value of 0.4, a balance parameter value for blockchain X (b_{y,x}) having a value of 50, a balance parameter value for blockchain Z (b_{y,z}) having a value of 50, an LKB parameter for blockchain X (lkb_{x,y}) having a value of 60, an LKB parameter for blockchain Z (lkb_{z,y}) having a value of 40, a credit parameter value for blockchain X (c_{y,x}) having a value of 0, and a credit parameter value for blockchain Z (c_{y,z}) having a value of 0.

The set of state parameters for blockchain Z in the initial state includes a liquidity provided parameter (lp_{z}) having a value of 100, a digital assets parameter (a_{z}) having a value of 100, a weight parameter for blockchain X (w_{z,x}) having a value of 0.5, a weight parameter for blockchain Y (w_{z,y}) having a value of 0.6, a balance parameter value for blockchain X (b_{z,x}) having a value of 50, a balance parameter value for blockchain Y (b_{z,y}) having a value of 40, an LKB parameter for blockchain X (lkb_{x,z}) having a value of 50, an LKB parameter for blockchain Y (lkb_{y,z}) having a value of 50, a credit parameter value for blockchain X (c_{z,x}) having a value of 0, and a credit parameter value for blockchain Z (c_{z,y}) having a value of 0.

Each of blockchains X-Z initially has a digital asset parameter that equals their liquidity provided parameter (i.e., 100). Blockchains X and Z evenly weight their connections, which means that b_{y,x}, b_{z,x}, b_{x,z} and b_{y,z} are all equal (i.e., each are equal to 50). However, blockchain Y weighs its connection with blockchain X with a weight parameter of 0.6 and weighs its connected with blockchain Z with a weight parameter of 0.4. This means that blockchain Z can send up to a transfer size of 40 to blockchain Y, whereas blockchain X can send up to a transfer size of 60 to blockchain Y.

FIG. 10B shows a first transaction, Transaction 0, in which a user is requesting to transfer 40 units of a digital asset from blockchain X to blockchain Y (i.e., the transfer size is 40). Thus, in Transaction 0, blockchain X is the source blockchain and blockchains Y and Z are non-source blockchains, where blockchain Y is the destination blockchain of the non-source blockchains. Transaction 0 is shown as being divided into two steps, Step 0 represented by diagram 1000B and Step 1 represented by diagram 1010B.

During Step 0 of Transaction 0, the transfer request is received. Transaction 0 begins with the user depositing 40 units into the unified liquidity pool on blockchain X. Since the transfer size of 40 is less than the available balance of 60 indicated by the balance parameter for blockchain Y, the transfer can proceed. The digital assets parameter can be increased from 100 to 140, and the balance parameter for blockchain Y can be reduced from 60 to 20. A set of temporary parameters (“Temporaries”) associated with blockchain X is then determined. For example, the set of temporary parameters associated with blockchain X can include the difference value for blockchain Y (diff_{x,y}), the difference value for blockchain Z (diff_{x,z}), the total rebalance amount (total), and the adjusted transfer size (t′). As shown, the difference values for blockchain Y and blockchain Z are 0, the total rebalance amount is 0, and the adjusted transfer size is 40. In the case of Transaction 0, all of the LKBs are at their initial value, so the entire transfer size is split between the credit parameters for blockchains Y and Z proportionally based on the weight parameters for blockchains Y and Z. In this example, the credit parameters for blockchains Y and Z are each updated to 20 since the weight parameters are each equal to 0.5. Each number shown in parentheses indicates the line of the pseudocode shown in FIG. 8 during which the corresponding value is determined (e.g., parameter value).

During Step 1 of Transaction 0, a message is sent to provide notification of the transfer. More specifically, the message includes the transfer size (40) and an amount of outstanding credits indicated by the credit parameter for blockchain Y (20). The set of state parameters associated with blockchain X is then updated to reflect the amount of outstanding credits being sent to blockchain Y by updating LKB parameter for blockchain Y from 50 to 70 and updating the credit parameter for blockchain Y from 20 to 0. Additionally, upon receipt of the message, the set of state parameters associated with blockchain Y can be updated by updating the digital assets parameters from 100 to 60 to account for the transfer size of 40 being sent out of blockchain Y, updating the balance parameter for blockchain X from 50 to 70 to account for the 20 credits received from blockchain X, and updating and the LKB for blockchain X from 60 to 20 to account for the transfer size of 40. During Transaction 0, the set of state parameters related to blockchain Z are left untouched, since blockchain Z is neither a source chain nor a destination chain in Transaction 0. Blockchain Y can then grant 40 units of the digital asset to the user and commit the transfer, concluding the transfer process.

FIG. 10C shows a second transaction performed at some time after the first transaction, Transaction 1, in which a user is requesting to transfer 30 units of a digital asset from blockchain Y to blockchain Z (i.e., the transfer size is 30). Thus, in Transaction 1, blockchain Y is the source blockchain and blockchains X and Z are non-source blockchains, where blockchain Z is the destination blockchain of the non-source blockchains. Similar to Transaction 0, Transaction 1 is shown as being divided into two steps, Step 0 represented by diagram 1000C and Step 1 represented by diagram 1010C. Transaction 1 illustrates how the resource balancing method works to dynamically rebalance non-source blockchain balances during a transaction.

During Step 0 of Transaction 1, the transfer request is received. Transaction 1 begins with the user depositing 30 units into the unified liquidity pool on blockchain Y. Since the transfer size of 30 is less than the available balance of 50 indicated by the balance parameter for blockchain Z, the transfer can proceed. The digital assets parameter can be increased from 60 to 90, and the balance parameter for blockchain Z can be reduced from 50 to 20. A set of temporary parameters (“Temporaries”) associated with blockchain Y is then determined. For example, the set of temporary parameters associated with blockchain Y can include the difference value for blockchain X (diff_{y,x}), the difference value for blockchain Z (diff_{y,z}), the total rebalance amount (total), and the adjusted transfer size (t′). As shown, the difference value for blockchain X is 30, the difference value for blockchain Z is 0, the total rebalance amount is 40, and the adjusted transfer size is 10. As discussed above, in Transaction 0, all of the LKBs were at their initial value, so the entire transfer size is split between the credit parameters for blockchains Y and Z proportionally based on the weight parameters for blockchains Y and Z. However, the primary difference compared to Transaction 0 is that the LKB balance value for blockchain X is 20, reflecting the withdrawal of 40 units the occurred in Step 1 of Transaction 0. As such, the difference between the current value of 20 and the initial value of 60 is calculated to be 40. However, this difference is larger than the transfer size of 30, so the difference is capped to the transfer size of 30. This means that the transfer size of 30 will be fully distributed to blockchain X to remove the balance for blockchain Y (b_{x,y}) as close as possible to its initial value of 60. Despite the fact that the destination blockchain of Transaction 1 is blockchain Z, the entire transaction amount is used to replenish the bandwidth of the connection from blockchain Y to blockchain X. Thus, in Transaction 1, the credit parameter for blockchain X is updated from 0 to 30, while the credit parameter for blockchain Z remains at 0. Each number shown in parentheses indicates the line of the pseudocode shown in FIG. 8 during which the corresponding value is determined (e.g., parameter value).

During Step 1 of Transaction 1, a message is sent to provide notification of the transfer. More specifically, the message includes the transfer size (30) and an amount of outstanding credits indicated by the credit parameter for blockchain Z (0). Since 0 credits are being sent to blockchain Z, no updates are made to the LKB parameter and the credit parameter for blockchain Z with respect to the set of state parameters associated with blockchain Y. Additionally, upon receipt of the message, the set of state parameters associated with blockchain Z can be updated by updating the digital assets parameters from 100 to 70 to account for the transfer size of 30 being sent out of blockchain Z, keeping the balance parameter for blockchain Y the same due to the 0 credits received from blockchain Y, and updating the LKB for blockchain Y from 50 to 20 to account for the transfer size of 30 received from blockchain Y. During Transaction 1, the set of state parameters related to blockchain X is left untouched, since blockchain X is neither a source chain nor a destination chain in Transaction 1. Blockchain Z can then grant 30 units of the digital asset to the user and commit the transfer, concluding the transfer process.

FIG. 10D shows a third transaction performed at some time after the second transaction, Transaction 2, in which a user is requesting to transfer 20 units of a digital asset from blockchain Y to blockchain X (i.e., the transfer size is 20). Thus, in Transaction 2, blockchain Y is the source blockchain and blockchains X and Z are non-source blockchains, where blockchain X is the destination blockchain of the non-source blockchains. Similar to Transactions 0 and 1, Transaction 2 is shown as being divided into two steps, Step 0 represented by diagram 1000D and Step 1 represented by diagram 1010D. Transaction 2 illustrates how credits from previous transactions can be piggybacked onto new user requests and how the resource balancing method handles different weight parameters.

During Step 0 of Transaction 2, the transfer request is received. Transaction 2 begins with the user depositing 20 units into the unified liquidity pool on blockchain Y. Since the transfer size of 20 is less than the available balance of 70 indicated by the balance parameter for blockchain X, the transfer can proceed. The digital assets parameter can be increased from 90 to 110, and the balance parameter for blockchain X can be reduced from 70 to 50. A set of temporary parameters (“Temporaries”) associated with blockchain Y is then determined. For example, the set of temporary parameters associated with blockchain Y can include the difference value for blockchain X (diff_{y,x}), the difference value for blockchain Z (diff_{y,z}), the total rebalance amount (total), and the adjusted transfer size (t′). As shown, the difference value for blockchain X is 10, the difference value for blockchain Z is 0, the total rebalance amount is 10, and the adjusted transfer size is 10. Since the LKB parameter for blockchain X is below its initial value, the transfer size of 20 is divided and applied as follows: (1) 10 units are used to restore the LKB parameter for blockchain X back to its initial value of 60 and (2) 10 units are divided between blockchain X and blockchain Z in a manner proportional to their assigned weights, giving additional credits of 6 to blockchain X and 4 to blockchain Z. Thus, in Transaction 2, the credit parameter for blockchain X is updated from 30 to 46, and the credit parameter for blockchain Z is updated from 0 to 4. Each number shown in parentheses indicates the line of the pseudocode shown in FIG. 8 during which the corresponding value is determined (e.g., parameter value).

During Step 1 of Transaction 1, a message is sent to provide notification of the transfer. More specifically, the message includes the transfer size (20) and an amount of outstanding credits indicated by the credit parameter for blockchain Z (46). Since 46 credits are being sent to blockchain Z, the LKB parameter for blockchain X is updated from 20 to 46, and the credit parameter for blockchain X is updated to 0. Additionally, upon receipt of the message, the set of state parameters associated with blockchain X can be updated by updating the digital assets parameters from 140 to 120 to account for the transfer size of 20 being sent out of blockchain X, updating the balance parameter for blockchain Y from 20 to 66 due to the 46 credits received from blockchain Y, and updating the LKB for blockchain Y from 70 to 50 to account for the transfer size of 20 received from blockchain Y. During Transaction 1, the set of state parameters related to blockchain X is left untouched, since blockchain X is neither a source chain nor a destination chain in Transaction 1. Blockchain Z can then grant 30 units of the digital asset to the user and commit the transfer, concluding the transfer process.

By piggybacking accumulated credits onto user requests, as demonstrated in, e.g., Transaction 2, the resource balancing method can conduct transfers and rebalance connections with a small number of transactions. Minimizing the number of transactions can reduce computational complexity and improve performance by reducing the number of transactions that are computationally costly to commit. Accordingly, utilizing resource balancing methods described herein can increase scalability of bridges that are used to facilitate transactions within a network. FIG. 10E shows a diagram 1000E of a resolved state after Transaction 2 is completed.

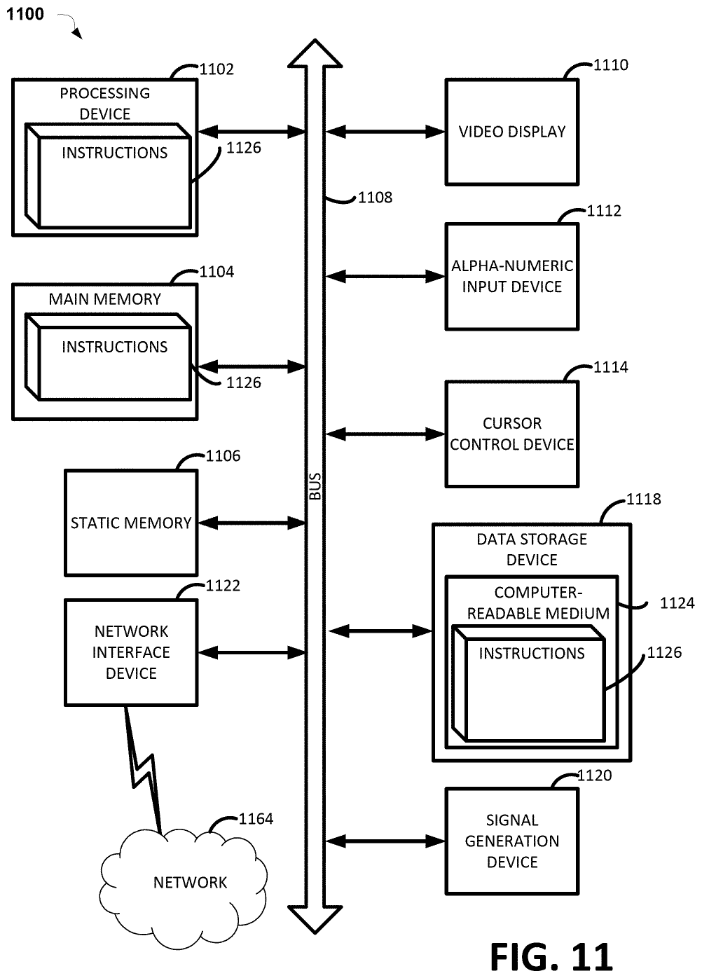

FIG. 11 depicts a block diagram of a computer system 1100 operating in accordance with one or more aspects of the disclosure. In various illustrative examples, computer system 1100 may correspond to one or more components of system 100 of FIG. 1, system 200 of FIG. 2 and/or system 600 of FIG. 6. Computer system 1100 may be included within a data center that supports virtualization. Virtualization within a data center can result in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical computing environment, but requests for a hard disk or memory may be managed by a virtualization layer of a computing device to translate these requests to the underlying physical computing hardware resources. This type of virtualization results in multiple VMs sharing physical resources.

In certain implementations, computer system 1100 may be connected (e.g., via a network 1164, such as a Local Area Network (LAN), an intranet, an extranet, or the Internet) to other computer systems. Computer system 1100 may operate in the capacity of a server or a client computer in a client-server environment, or as a peer computer in a peer-to-peer or distributed network environment. Computer system 1100 may be provided by a personal computer (PC), a tablet PC, a set-top box (STB), a Personal Digital Assistant (PDA), a cellular telephone, a web appliance, a server, a network router, switch or bridge, or any device capable of executing a set of executable instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1100 may include a processing device 1102, a volatile memory 1104 (e.g., random access memory (RAM)), a non-volatile memory 1106 (e.g., read-only memory (ROM) or electrically-erasable programmable ROM (EEPROM)), and a data storage device 1116, which may communicate with each other via a bus 1108.

Processing device 1102 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 1100 may further include a network interface device 1122. Computer system 1100 also may include a video display unit 1110 (e.g., an LCD), an alphanumeric input device 1112 (e.g., a keyboard), a cursor control device 1114 (e.g., a mouse), and a signal generation device 1120. Data storage device 1116 may include a non-transitory computer-readable storage medium 1124 on which may store instructions 1126 encoding any one or more of the methods or functions described herein. Instructions 1126 may also reside, completely or partially, within volatile memory 1104 and/or within processing device 1102 during execution thereof by computer system 1100, hence, volatile memory 1104 and processing device 1102 may also constitute machine-readable storage media.

While computer-readable storage medium 1124 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of executable instructions for execution by a computer that cause the computer to perform any one or more of the methods described herein. The term “computer-readable storage medium” shall include, but not be limited to, solid-state memories, optical media, and magnetic media.

Other computer system designs and configurations may also be suitable to implement the system and methods described herein. The following examples illustrate various implementations in accordance with one or more aspects of the present disclosure.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner. In certain implementations, not all operations or sub-operations of the methods herein are required to be performed.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that aspects of the present disclosure may be practiced without these specific details. In some instances, well-known structures and devices are shown in block diagram form, rather than in detail, in order to avoid obscuring the present disclosure.

Unless specifically stated otherwise, as apparent from the following discussion, it is appreciated that throughout the description, discussions utilizing terms such as “obtaining,” “receiving,” “executing,” “sending,” “initiating,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the specific purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the disclosure presented herein are not inherently related to any particular computer or other apparatus. Various general purpose systems may be used with programs in accordance with the teachings herein, or it may prove convenient to construct more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not have an ordinal meaning according to their numerical designation.

What is claimed is:

1. A system comprising:
a memory; and
a processing device, operatively coupled to the memory, to perform operations comprising:
receiving a request to transfer an amount of a digital asset from a source blockchain having an associated unified liquidity pool to a destination blockchain of a set of non-source blockchains, wherein the amount of the digital asset defines a transfer size of the transfer;
determining whether to initiate the transfer by comparing the transfer size to a balance parameter for the destination blockchain, wherein the balance parameter for the destination blockchain is comprised within a set of state parameters associated with the source blockchain;
in response to determining to initiate the transfer, updating the set of state parameters associated with the source blockchain to obtain an updated set of state parameters; and
sending, to a destination node maintaining the destination blockchain, a message indicative of a subset of state parameters of the updated set of state parameters, wherein the subset of state parameters comprises the transfer size and a credit parameter for the destination blockchain.

2. The system of claim 1, wherein the balance parameter for the destination blockchain corresponds to a portion of digital assets on the destination blockchain that can be used to facilitate transfers from the source blockchain.

3. The system of claim 1, wherein updating the set of state parameters associated with the source blockchain further comprises updating, based on the transfer size, a digital asset parameter corresponding to a size of the unified liquidity pool.

4. The system of claim 1, wherein updating the set of state parameters further comprises updating, for each non-source blockchain of the set of non-source blockchains, a credit parameter, and wherein the credit parameter for each non-source blockchain of the set of non-source blockchains corresponds to an amount of digital assets that can be sent to the non-source blockchain.

5. The system of claim 4, wherein, for each non-source blockchain of the set of non-source blockchains, updating the credit parameter further comprises:
determining, for each non-source blockchain of the set of non-source blockchains, a respective difference value based on the set of state parameters;
determining a total rebalance amount by adding each difference value;
determining, for each non-source blockchain of the set of non-source blockchains based on the total rebalance amount and the transfer size, an amount of digital assets to allocate to the non-source blockchain by determining a portion of the transfer size to be allocated to the non-source blockchain;
allocating, to each non-source blockchain, the portion of the transfer size to the non-source blockchain; and
determining an adjusted transfer size defined as a portion of the transfer size that remains after allocating, to each non-source blockchain, the portion of the transfer size to the non-source blockchain.

6. The system of claim 5, wherein, for each non-source blockchain of the set of non-source blockchains, the respective difference value is determined based on a liquidity provided parameter of the set of state parameters corresponding to an amount of liquidity associated with the unified liquidity pool, a weight parameter for the non-source blockchain of the set of state parameters, a last known balance parameter for the non-source blockchain of the set of state parameters, and the credit parameter.

7. The system of claim 5, wherein:
determining the amount of digital assets to allocate to each non-source blockchain further comprises determining, for each non-source blockchain, an adjusted difference value defining the respective portion of the transfer size based on the transfer size, the total rebalance amount, and a ratio of the difference value for the non-source blockchain and the total rebalance amount;
updating, for each non-source blockchain of the set of non-source blockchains, the credit parameter, further comprises further comprises restoring, for each non-source blockchain of the set of non-source blockchains, a current balance of the non-source blockchain to its initial value by adding, to each non-source blockchain, a respective number of credits to a current number of credits indicated by the credit parameter for the non-source blockchain; and
the number of credits for the non-source blockchain is determined based on the adjusted difference value for the non-source blockchain and the adjusted transfer size.

8. The system of claim 1, wherein the operations further comprise updating the updated set of state parameters after sending the message, and wherein updating the updated set of parameters after sending the message further comprises:
updating a last known balance parameter for the destination blockchain; and
setting the credit parameter for the destination blockchain to zero.

9. A method comprising:
receiving, by a processing device, a request to transfer an amount of a digital asset from a source blockchain having an associated unified liquidity pool to a destination blockchain of a set of non-source blockchains, wherein the amount of the digital asset defines a transfer size of the transfer;
determining, by the processing device, whether to initiate the transfer by comparing the transfer size to a balance parameter for the destination blockchain, wherein the balance parameter for the destination blockchain is comprised within a set of state parameters associated with the source blockchain;
in response to determining to initiate the transfer, updating, by the processing device, the set of state parameters associated with the source blockchain to obtain an updated set of state parameters; and
sending, by the processing device to a destination node maintaining the destination blockchain, a message indicative of a subset of state parameters of the updated set of state parameters, wherein the subset of state parameters comprises the transfer size and a credit parameter for the destination blockchain.

10. The method of claim 9, wherein the balance parameter for the destination blockchain corresponds to a portion of digital assets on the destination blockchain that can be used to facilitate transfers from the source blockchain.

11. The method of claim 9, wherein updating the set of state parameters associated with the source blockchain further comprises updating, based on the transfer size, a digital asset parameter corresponding to a size of the unified liquidity pool.

12. The method of claim 9, wherein updating the set of state parameters further comprises updating, for each non-source blockchain of the set of non-source blockchains, a credit parameter, and wherein the credit parameter for each non-source blockchain of the set of non-source blockchains corresponds to an amount of digital assets that can be sent to the non-source blockchain.

13. The method of claim 12, wherein for each non-source blockchain of the set of non-source blockchains, updating the credit parameter further comprises:
determining, for each non-source blockchain of the set of non-source blockchains, a respective difference value based on the set of state parameters;
determining a total rebalance amount by adding each difference value;
determining, for each non-source blockchain of the set of non-source blockchains based on the total rebalance amount and the transfer size, an amount of digital assets to allocate to the non-source blockchain by determining a portion of the transfer size to be allocated to the non-source blockchain;
allocating, to each non-source blockchain, the portion of the transfer size to the non-source blockchain; and
determining an adjusted transfer size defined as a portion of the transfer size that remains after allocating, to each non-source blockchain, the portion of the transfer size to the non-source blockchain.

14. The method of claim 13, wherein, for each non-source blockchain of the set of non-source blockchains, the respective difference value is determined based on a liquidity provided parameter of the set of state parameters corresponding to an amount of liquidity associated with the unified liquidity pool, a weight parameter for the non-source blockchain of the set of state parameters, a last known balance parameter for the non-source blockchain of the set of state parameters, and the credit parameter.

15. The method of claim 13, wherein:
determining the amount of digital assets to allocate to each non-source blockchain further comprises determining, for each non-source blockchain, an adjusted difference value defining the respective portion of the transfer size based on the transfer size, the total rebalance amount, and a ratio of the difference value for the non-source blockchain and the total rebalance amount;
updating, for each non-source blockchain of the set of non-source blockchains, the credit parameter, further comprises further comprises restoring, for each non-source blockchain of the set of non-source blockchains, a current balance of the non-source blockchain to its initial value by adding, to each non-source blockchain, a respective number of credits to a current number of credits indicated by the credit parameter for the non-source blockchain; and
the number of credits for the non-source blockchain is determined based on the adjusted difference value for the non-source blockchain and the adjusted transfer size.

16. The method of claim 9, further comprising updating, by the processing device, the updated set of state parameters after sending the message, and wherein updating the updated set of parameters after sending the message further comprises:
updating a last known balance parameter for the destination blockchain; and
setting the credit parameter for the destination blockchain to zero.

17. A system comprising:
a source node maintaining a source blockchain of a network, wherein the source blockchain has an associated unified liquidity pool, and wherein the source blockchain is associated with a set of state parameters; and
a set of non-source nodes of the network, each non-source node maintaining a respective non-source blockchain, wherein the set of non-source nodes comprises a destination node maintaining a destination blockchain;
wherein the source node comprises a processing device, operatively coupled to a memory, to perform operations comprising:
receiving a request to transfer an amount of a digital asset to the destination blockchain, wherein the amount of the digital asset defines a transfer size of the transfer;
determining whether to initiate the transfer by comparing the transfer size to a balance parameter for the destination blockchain, wherein the balance parameter for the destination blockchain is comprised within the set of state parameters associated with the source blockchain;
in response to determining to initiate the transfer, updating the set of state parameters associated with the source blockchain to obtain an updated set of state parameters; and
sending, to the destination node, a message indicative of a subset of state parameters of the updated set of state parameters, wherein the subset of state parameters comprises the transfer size and a credit parameter for the destination blockchain.

18. The system of claim 17, wherein:
the balance parameter for the destination blockchain corresponds to a portion of digital assets on the destination blockchain that can be used to facilitate transfers from the source blockchain;
updating the set of state parameters associated with the source blockchain further comprises updating, based on the transfer size, a digital asset parameter corresponding to a size of the unified liquidity pool; and
updating the set of state parameters further comprises updating, for each non-source blockchain of the set of non-source blockchains, a credit parameter for the non-source blockchain, and wherein the credit parameter for each non-source blockchain of the set of non-source blockchains corresponds to an amount of digital assets that can be sent to the non-source blockchain.

19. The system of claim 18, wherein, for each non-source blockchain of the set of non-source blockchains, updating the credit parameter further comprises:
determining, for each non-source blockchain of the set of non-source blockchains, a respective difference value based on the set of state parameters;
determining a total rebalance amount by adding each difference value;
determining, for each non-source blockchain of the set of non-source blockchains based on the total rebalance amount and the transfer size, an amount of digital assets to allocate to the non-source blockchain by determining a portion of the transfer size to be allocated to the non-source blockchain;
allocating, to each non-source blockchain, the portion of the transfer size to the non-source blockchain; and
determining an adjusted transfer size defined as a portion of the transfer size that remains after allocating, to each non-source blockchain, the portion of the transfer size to the non-source blockchain.

20. The system of claim 17, wherein the operations further comprise updating the updated set of state parameters after sending the message, and wherein updating the updated set of parameters after sending the message further comprises:
updating a last known balance parameter for the destination blockchain; and
setting the credit parameter for the destination blockchain to zero.
